(19) United States
(12) Patent Application Publication
(10) Pub. No.: US 2019/0007500 A1
(43) Pub. Date: Jan. 3, 2019

(54) METHOD FOR PROTOCOL DATA UNIT (PDU) SESSION ANCHOR RELOCATION AND 5G NETWORK REGISTRATION

(71) Applicant: Electronics and Telecommunications Research Institute, Daejeon (KR)

(72) Inventors: Dongmyoung Kim, Sejong-si (KR); Myung Ki Shin, Seoul (KR); Soohwan Lee, Daejeon (KR); Seung- Ik Lee, Daejeon (KR)

(73) Assignee: Electronics and Telecommunications Research Institute, Daejeon (KR)

(21) Appl. No.: 16/026,291

(22) Filed: Jul. 3, 2018

(30) Foreign Application Priority Data
Jul. 3, 2017 (KR) 10-2017-0084487
Nov. 24, 2017 (KR) 10-2017-0158770
May 10, 2018 (KR) 10-2018-0053610

(51) Int. Cl. H04L 29/08

(52) U.S. Cl. CPC H04L 67/141

(57) ABSTRACT

Provided is a method of relocating a session and service continuity (SSC) mode 2 protocol data unit (PDU) session anchor by a session management function (SMF) device, the method including determining a relocation of a PDU session anchor; releasing a PDU session associated with an old PDU session anchor by sending, to a user equipment (UE), N1 SM information including a PDU session release command message through an access and mobility management function (AMF) device; and selecting a new PDU session anchor to establish a PDU session associated with the new PDU session anchor.

### CROSS-REFERENCE TO RELATED APPLICATION(S)

This application claims the priority benefit of Korean Patent Application No. 10-2017-0084487 filed on Jul. 3, 2017, Korean Patent Application No. 10-2017-0158770 filed on Nov. 24, 2017, and Korean Patent Application No. 10-2018-0053610 filed on May 10, 2018 in the Korean Intellectual Property Office, the disclosures of which are incorporated herein by reference for all purposes.

### BACKGROUND

### 1. Field

One or more example embodiments relate to a method for relocating a protocol data unit (PDU) session anchor and registering a 5G network.

### 2. Description of Related Art

A mobile edge computing (MEC) technique is proposed to provide a low latency data service in a user equipment (UE). The MEC technique is used to minimize a round trip time (RTT) between the UE and a server that provides a service requested by the UE. The MEC technique relates to reducing a number of routing hops between the UE and the server and to deploying a geographical location of the server to be close to the UE.

In a 5G mobile communication network, a variety of services may be provided to the UE through a 5G network technique. Accordingly, the 5G mobile communication network may support an edge computing technique to provide the further enhanced quality of service (QoS) compared to an existing network scheme.

### SUMMARY

At least one example embodiment provides a process of performing a registration procedure in a 5G network.

At least one example embodiment also provides a process of performing a user equipment (UE) triggered service request procedure.

At least one example embodiment also provides a process of relocating a protocol data unit (PDU) session anchor.

According to an aspect of at least one example embodiment, there is provided a network registration method performed by a new access and mobility management function (AMF) device, the method including receiving a registration request message of a user equipment (UE) over an access network; and sending, to the UE, a registration accept message indicating that a registration request is accepted. The registration request message of the UE includes i) a method for performing an initial registration of the UE in a DEREGISTERED state, ii) a message for performing a mobility registration update in response to mobility of the UE that is in a REGISTERED state, iii) a message for performing a periodic registration update of the UE that is in the REIGSTERED state, or iv) a message for performing an emergency registration of the UE that is in a limited service state.

The new AMF device that receives the registration request message may be configured to send, to an old AMF device, a Namf_Communication_UEContextTransfer message requesting a subscription permanent identifier (SUPI) and a mobility management (MM) context of the UE in response to the new AMF device not receiving a UE context from the old AMF device during a handover procedure.

The new AMF device may be configured to send a new registration area to the UE through the registration accept message in response to allocation of the new registration area.

According to an aspect of at least one example embodiment, there is provided a service request method of a UE performed by an AMF device, the method including receiving an N2 message from an access network that receives a service request message from the UE; and sending, to the access network, an N2 request including N2 session management (SM) information received from a session management function (SMF) device. In response to the service request message being not sent integrity protected or integrity protection verification failed, the AMF device is configured to initiate a NAS authentication procedure with the UE and a NAS security procedure with an authentication server function (AUSF).

For the UE in a connection management (CM)-CONNECTED state, the N2 request may include the N2 SM information and mobility management (MM) NAS service accept.

The MM NAS service accept may include a PDU session status in the AMF device.

According to an aspect of at least one example embodiment, there is provided a method of relocating a session and service continuity (SSC) mode 2 PDU session anchor by an SMF device, the method including determining a relocation of a PDU session anchor; releasing a PDU session associated with an old PDU session anchor by sending, to a UE, N1 SM information that includes a PDU session release command message through an AMF device; and selecting a new PDU session anchor to establish a PDU session associated with the new PDU session.

The PDU session release command message may include a PDU session ID that needs to be relocated.

According to an aspect of at least one example embodiment, there is provided a method of relocating an SSC mode 2 PDU session anchor by a UE, the method including receiving N1 session management (SM) information that includes a PDU session release command message through an AMF device in response to a relocation of a PDU session anchor being determined by an SMF device; and releasing a PDU session associated with an old PDU session anchor and establishing a PDU session associated with a new PDU session.

The PDU session release command message may include a PDU session ID that needs to be relocated.

According to an aspect of at least one example embodiment, there is provided a method of relocating an SSC mode 2 PDU session anchor by an AMF device, the method including sending, to a UE, N1 SM information that includes a PDU session release command message in response to a relocation of a PDU session anchor being determined by an SMF device; and selecting, by the AMF device, the SMF device that selects a new PDU session anchor in response to the UE creating a new PDU session ID to release a PDU session associated with an old PDU session anchor and to establish a PDU session associated with the new PDU session anchor.

The PDU session release command message may include a PDU session ID that needs to be relocated.

According to an aspect of at least one example embodiment, there is provided a method of relocating an SSC mode 3 PDU session anchor by a UE, the method including receiving a PDU session modification command message from an AMF device in response to a relocation of a PDU session anchor being determined by an SMF device; establishing a PUD session with a new PDU session anchor in response to the received PDU session modification command message; and releasing a PDU session associated with an old PDU session anchor before expiry of a timer indicating a time in which an old PDU session is maintained after establishment of the PDU session associated with the new PDU session anchor.

The establishing of the PDU session may include relocating the SSC mode 3 PDU session anchor after expiry of a registration request procedure or a service request procedure of the UE.

According to an aspect of at least one example embodiment, there is provided a method of relocating an SSC mode 3 PDU session anchor by an SMF device, the method including determining a relocation of a PDU session anchor; sending, to an AMF device, Namf_Communication_N1N2MessageTransfer that includes a PDU session ID indicating a PDU session to be relocated; and releasing a PDU session associated with an old PDU session anchor after establishment of a PDU session between a UE and a new PDU session anchor.

The Namf_Communication_N1N2MessageTransfer may include a cause indicating that a PDU session re-establishment in the same data network is required and information regarding whether the SMF device needs to be reallocated.

The old PDU session anchor may release an old PDU session using the UE before expiry of a timer indicating a time in which the old PDU session is maintained or may release the old PDU session using the SMF device until the timer expires.

According to an aspect of at least one example embodiment, there is provided a method of relocating an SSC mode 3 PDU session anchor by an AMF device, the method including receiving Namf_Communication_N1N2MessageTransfer that includes a PDU session ID indicating a PDU that needs to be relocated in response to an SMF device determining a relocation of a PDU session anchor from an old PUD session anchor to a new PDU session anchor; and sending, to a UE, a PDU session modification command message that includes a cause indicating that a PDU session re-establishment in the same data network is required and a time in which a PDU session is maintained.

The Namf_Communication_N1N2MessageTransfer may include information regarding whether the SMF device needs to be reallocated.

The old PDU session anchor may release an old PDU session using the UE before expiry of a timer indicating a time in which the old PDU session is maintained or may release the old PDU session using the SMF device until the timer expires.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a registration management (RM) state model of a user equipment (UE) according to an example embodiment;

FIG. 2 illustrates an example of an RM state model of an access and mobility management function (AMF) device according to an example embodiment;

FIG. 3 illustrates an example of a connection management (CM) state transition in a UE according to an example embodiment;

FIG. 4 illustrates an example of a CM state transition in an AMF device according to an example embodiment;

FIG. 5 illustrates an example of a user plane (UP) architecture of an uplink classifier according to an example embodiment;

FIG. 6 illustrates an example of a multi-homed PDU session used to support a service continuity according to an example embodiment;

FIG. 7 illustrates an example of a multi-homed PDU session used to support a local access to the same data network according to an example embodiment;

FIG. 8 illustrates an example of an N4 session establishment procedure according to an example embodiment;

FIG. 9 illustrates an example of an N4 session modification procedure according to an example embodiment;

FIG. 10 illustrates an example of an N4 session release procedure according to an example embodiment;

FIG. 11 illustrates an example of a UE registration procedure in a communication system according to an example embodiment;

FIGS. 12A and 12B illustrate an example of a UE triggered service request procedure according to an example embodiment;

FIG. 13 illustrates an example of a change procedure of a session and service continuity (SSC) mode 2 PSA for a PDU session according to an example embodiment;

FIG. 14 illustrates an example of a change procedure of an SSC mode 3 PDU session anchor with a plurality of PDU sessions according to an example embodiment;

FIGS. 15A and 15B illustrate an example of a UE registration procedure in a communication system according to an example embodiment;

FIGS. 16a and 16b illustrate an example of a UE triggered service request procedure in a CM-IDLE state according to an example embodiment;

FIGS. 17A and 17B illustrate an example of a UE triggered service request procedure in a CM-CONNECTED state according to an example embodiment; and

FIGS. 18A and 18B illustrate another example of a UE registration procedure in a communication system according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it should be noted that if it is described that one component is “directly connected,” “directly coupled,” or “directly joined” to another component, a third component may be absent. Expressions describing a relationship between components, for example, “between,” directly between,” or “directly neighboring,” etc., should be interpreted to be alike.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described with reference to the accompanying drawings.

### Definitions

5G access network: refers to an access network that includes an NG-RAN and/or non-3GPP AN connecting to a 5G core network.
5G core network: connects to the 5G access network.
5G system: refers to a 3GPP system that includes the 5G access network, the 5G core network, and a user equipment (UE).
Allowed area: refers to an area in which the UE is allowed to initiate communication.
AMF region: refers to an AMF region that includes one or more access and mobility management function (AMF) sets.
Local area data network: refers to a data network (DN) that is accessible by the UE in a specific location, that provides connectivity to a specific DNN, and of which availability is provided to the UE.
NG-RAN: refers to a radio access network (RAN) that supports at least one of the following options with the common characteristics that it connects to the 5G core network: 1) standalone new radio; 2) new radio is an anchor with E-UTRA extensions; 3) standalone E-UTRA; and 4) E-UTRA is an anchor with new radio extensions.
Protocol data unit (PDU) session: refers to an association between the UE and a data network that provides a PDU connectivity service.
PDU connectivity service: refers to a service that provides exchange of PDUs between the UE and the data network.
PDU session type: refers to a type of a PDU session that may be IPv4, IPv6, Ethernet, or unstructured.
Service continuity: refers to uninterrupted user experience of a service, including a case in which an IP address and/or an anchoring point change.
Session continuity: refers to a continuity of a PDU session. For a PDU session of IPv4 or IPv6 type, “session continuity” indicates that an IP address is preserved for lifetime of the PDU session.

### Abbreviations

5GC: core network
5GS: 5G system
5G-AN: 5G access network
5G-GUTI: 5G globally unique temporary identifier
AMF: access and mobility management function
AUSF: authentication server function
CP: control plane
DL: downlink
DN: data network
DNN: data network name
HR: home routed (roaming)
LADN: local area data network
MICO: mobile initiated connection only
N3IWF: non-3GPP inter working function
NAI: network access identifier
NF: network function
NR: new radio
NEF: network exposure function
NRF: network repository function
PCF: policy control function
(R)AN: (radio) access network
SSC: session and service Continuity
SUCI: subscription concealed identifier
SUPI: subscription permanent identifier
UL: uplink
UL CL: uplink classifier
UPF: user plane function

In the following, each of a session management function (SMF), an access and mobility management function (AMF), and a user plane function (UPF) may be a software function, or may be installed or executed on each of multiple hardware modules.

<Concepts>

A 5G system architecture is defined to support data connectivity and services using techniques such as, for example, network function virtualization (NFV) and software defined networking (SDN). The 5G system architecture may leverage service-based interactions between control plane (CP) network functions. Some key principles and concept follow as:

i) separate user plane (UP) functions from control plane (CP) functions, allowing independent scalability, evolution, and flexible deployments, for example, a centralized location or a distributed (remote) location; ii) modularize a function design, for example, to enable flexible and efficient network slicing; iii) if applicable, define procedures (i.e., a set of interactions between network functions) as services, so their reuse is possible; iv) enable each network function to interact with other network functions directly if necessary (here, the architecture does not preclude the use of an intermediate function to help route CP messages); v) minimize dependency between the access network (AN) and the core network (CN) (here, the architecture is defined with a converged core network with a command AN-CN interface that integrates different access type)s; vi) support a unified authentication framework; vii) support “stateless” NFs in which a “compute” resource is decoupled from a “storage” resource; viii) support capability exposure; ix) support a concurrent access to local and centralized services (here, to support low latency services and an access to local data networks, UP functions may be deployed close to the access network); and x) support roaming with both home routed traffic as well as Local breakout traffic in a visited PLMN.

<Architecture Reference Model>

Here, an architecture of the 5G system is described. The 5G system architecture is defined as a service-based architecture and an interaction between network functions is represented in the following two ways:

i) A service-based representation describes that network functions, for example, an AMF, within a control plane enable other authorized network functions to access services of the network functions. The service-based representation may include a point-to-point reference point if necessary. ii) A reference point representation describes that an interaction is present between NF services in network functions described by a point-to-point reference point, for example, N11, between any two network functions, for example, an AMF and an SMF.

<Service-Based Interface>

The 5G system architecture includes the following service-based interfaces:

i) Namf: a service-based interface exhibited by an AMF; ii) Nsmf: a service-based interface exhibited by an SMF; iii) Nnef: a service-based interface exhibited by an NEF; iv) Npcf: a service-based interface exhibited by a PCF; v) Nudm: a service-based interface exhibited by a unified data management (UDM); vi) Naf: a service-based interface exhibited by an AF; vii) Nnrf: a service-based interface exhibited by an NRF; viii) Nnssf: a service-based interface exhibited by an NSSF; ix) Nausf: a service-based interface exhibited by an AUSF; x) Nudr: a service-based interface exhibited by a UDR; and xi) Nudsf: a service-based interface exhibited by a UDSF.

<Reference Points>

The 5G system architecture includes the following reference points:

1) N1: a reference point between a UE and an AMF device; 2) N2: a reference point between an access network and the AMF device; 3) N3: a reference point between the access network and a UPF device; 4) N4; a reference point between an SMF device and the UPF device; 5) N6: a reference point between the UPF device and a data network; and 6) N9: reference point between UPF devices.

The following reference points describe interactions that are present between NF services in NFs. The reference points are realized by corresponding NF service-based interfaces and by specifying an identified consumer and producer NF service as well as interaction therebetween to realize a specific system procedure:

1) N5: a reference point between a PCF and an AF; 2) N7: a reference point between the SMF device and the PCF; 3) N8: a reference point between a UDM and the AMF device; 4) N10: a reference point between the UDM and the SMF device; 5) N11: a reference point between the AMF device and the SMF device; 6) N12: a reference point between the AMF device and an AUSF; and 7) N14: a reference point between AMF devices.

<Registration Management>

The registration management is used to register or deregister a UE/user with a network, and to establish a user context in the network.

The UE/user needs to register with the network to receive a service that requires registration. Once registered and if applicable, the UE updates its registration with the network 1) periodically to remain reachable (period registration update); 2) upon mobility (mobility registration update); or 3) to update its capability or re-negotiate protocol parameters.

An initial registration procedure includes execution of network access control functions (i.e., user authentication and access authorization based on subscription files in UDM). As a result of the registration procedure, an identifier of a serving AMF device serving the UE in an access through which the UE is registered may be registered in the UDM.

The registration management procedure may be applied over a 3GPP access and a non-3GPP access. 3GPP and non-3GPP registration management (RM) states are mutually independent.

The following two RM states are used in the UE and the AMF device that reflect a registration status of the UE in the selected PLMN: i) RM-DEREGISTERED and ii) RM-RE GI STERED.

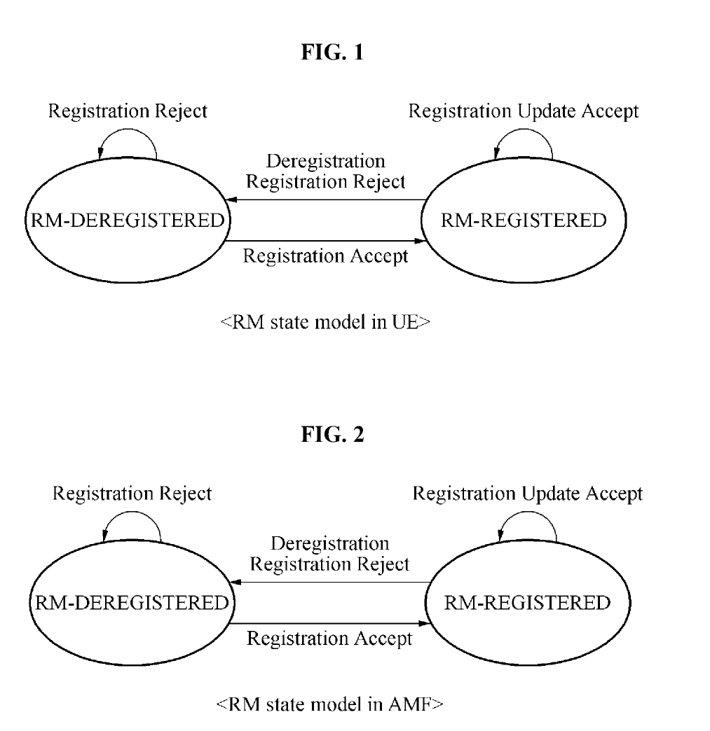

FIG. 1 illustrates an example of a registration management (RM) state model of a UE according to an example embodiment, and FIG. 2 illustrates an example of an RM state model of an AMF device according to an example embodiment.

1. RM-DEREGISTERED State

In the RM-DEREGISTERED state, the UE is not registered with a network. A UE context in an AMF device holds no valid location or routing information for the UE. Therefore, the UE may not be reachable by the AMF device. However, a portion of the UE context may be stored in the UE and the AMF device, for example, to avoid running an authentication procedure during every registration procedure.

In the RM-DEREGISTERED state, the UE may i) attempt to register with the selected PLMN using the initial registration procedure if the UE needs to receive a service that requires registration; ii) remain in the RM-DEREGISTERED state if the UE receives a registration reject upon initial registration; and iii) enter an RM-REGISTERED state in response to receiving a registration accept.

When a UE RM state of the AMF device is RM-DEREGISED, the AMF device may i), if applicable, accept the initial registration of the UE by sending a registration accept to the UE and enter the RM-REGISTERED state for the UE; or ii), if applicable, reject the initial registration of the UE by sending a registration reject to the UE.

2. RM-REGISTERED State

In the RM-REGISTERED state, the UE is registered with the network. In the RM-REGISTERED state, the UE may receive a service that requires registration with the network.

In the RM-REGISTERED state, the UE may i) perform a mobility registration update procedure if a current TAI of a servicing cell is absent in a list of TAIs that the UE receives from the network to maintain the registration and enable the AMF device to page the UE; ii) perform a periodic registration update procedure triggered by expiry of a periodic update timer to notify the network that the UE is still active; iii) perform a registration update procedure to update its capability information or to re-negotiate parameters with the network; iv) perform a deregistration procedure and enter the RM-DEREGISTERED state when the UE needs to be no longer registered with the PLMN (the UE may determine to deregister from the network at any time); and v) enter the RM-DEREGISTERED state in response to receiving a registration reject message or a deregistration message. The actions of the UE depend on a cause value in a registration rejection message or a deregistration message.

When the UE RM state of the AMF device is RM-REGISTERED, the AMF device may i) perform a deregistration procedure and enter the RM-DEREGISTERED state for the UE when the UE needs to be no longer registered with the PLMN (the network may determine to deregister the UE at any time); ii) perform an implicit deregistration at any time after expiry of an implicit deregistration timer, and enter the RM-DEREGISTERED state for the UE after the Implicit deregistration; and iii), if applicable, accept or reject a registration request or a service request from the UE.

<Connection Management>

The connection management is used to establish or release a signaling connection between the UE and the AMF device. The connection management includes a function of establishing and releasing the signaling connection between the UE and the AMF device over N1. The signaling connection is used to enable NAS signaling exchange between the UE and the core network, and includes an access network (AN) signaling connection between the UE and the AN (an RRC connection over a 3GPP access or a UE-N3IWF connection over a non-3GPP access) and an N2 connection for the UE between the AN and the AMF device.

The following CM states are used to reflect a NAS signaling connection between the AMF device and the UE:

i) CM-IDLE; and ii) CM-CONNECTED.

The CM states for the 3GPP access and the non-3GPP access are mutually independent. That is, if one is in the CM-CONNECTED state, the other may be in the CM-IDLE state at the same time.

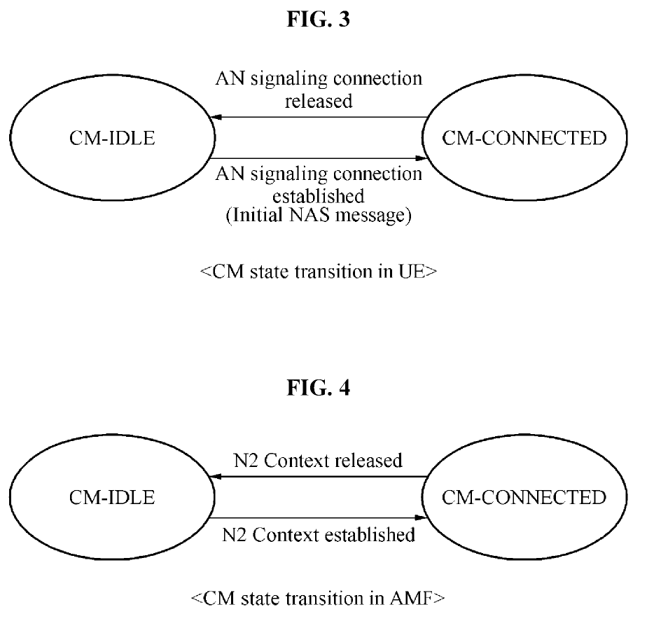

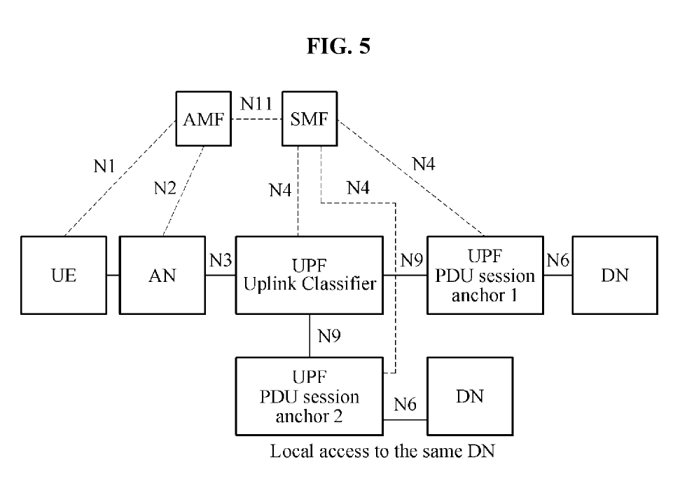

FIG. 3 illustrates an example of a connection management (CM) state transition in a UE according to an example embodiment, and FIG. 4 illustrates an example of a CM state transition in an AMF device according to an example embodiment.

CM-IDLE State

A UE in the CM-IDLE state has no signaling connection established with an AMF device over N1. The UE performs a cell selection/cell reselection and performs a PLMN selection.

The UE in the CM-IDLE state has no AN signaling connection, N2 connection, and N3 connection.

If the UE is in the CM-IDLE state and the RM-REGISTERED state, the UE may i) respond to paging by performing a service request procedure unless the UE is in a MICO mode; and ii) perform a service request procedure when the UE has uplink signaling or user data to be sent. Specific conditions are applied to LADN.

The UE may enter the CM-CONNECTED state every time an AN signaling connection is established between the UE and the AN. The UE may enter an RRC connected state over the 3GPP access or at the establishment of a UE-N3IWF connectivity over the non-3GPP access. Sending of an initial NAS message, for example, a registration request message, a service request message, or a deregistration request message, initiates a transition from the CM-IDLE state to the CM-CONNECTED state.

When the UE states in the AMF device are CM-IDLE and RM-REGISTERED, the AMF device may i) perform a network triggered service request procedure when the AMF device has signaling or mobile-terminated data to be sent to the UE by sending a paging request to the UE if the UE is not prevented from responding.

The AMF device may enter the CM-CONNECTED state for the UE every time an N2 connection is established for the UE between the AN and the AMF device.

Receiving of an initial N2 message, for example, an N2 initial UE message, initiates transition of the AMF device from the CM-IDLE state to the CM-CONNECTED state.

The UE and the AMF device may optimize the power efficiency and the signaling efficiency of the UE when the UE and the AMF device are in the CM-IDLE state.

CM-CONNECTED State

The UE in the CM-CONNECTED state has a NAS signaling connection with the AMF device over N1. The NAS signaling connection uses an RRC connection between the UE and an NG-RAN and an NGAP UE association between the AN and the AMF device. The UE may be in the CM-CONNECTED state with the NGAP UE association that is not bound to any TNLA between the AN and the AMF device. In response to completion of a NAS signaling procedure, the AMF device may determine to release the NAS signaling connection with the UE:

In the CM-CONNECTED state, the UE may i) enter the CM-IDLE state every time the AN signaling connection is released (enter an RRC idle state over the 3GPP access or when release of UE-N3IWF connectivity over the non-3GPP access is detected by the UE).

When a UE CM state in the AMF device is CM-CONNECTED, the AMF device may i) enter the CM-IDLE state for the UE every time a logical NGAP signaling connection and an N3 user plane connection for the UE are released in response to completion of the AN release procedure.

The AMF device may maintain the UE CM state in the AMF device to be in the CM-CONNECTED state until the UE deregisters from a core network.

The UE in the CM-CONNECTED state may be in an RRC inactive state. When the UE is in the RRC inactive state, the following applies i) UE reachability is managed by a RAN with assistance information from the core network; ii) UE paging is managed by the RAN; and iii) the UE monitors paging with a RAN identifier and CN (5G S-TMSI) of the UE.

<Session Management>

A 5G core network supports a PDU connectivity service. The PDU connectivity service is supported through PDU sessions that are established in response to a request from the UE.

Subscription information may include a plurality of data network names (DNNs) and a default DNN. The UE is assigned to the default DNN if a valid DNN is not provided in a PDU session establishment request sent to the 5G core network.

Each PDU session supports a single PDU session type. That is, each PDU session supports exchange of a single type of a PDU session requested by the UE at the establishment of the PDU session.

The PDU session may be established in response to a request from the UE, modified response to a request from the UE and the 5GC, and released in response to a request from the UE and the 5GC using NAS SM signaling exchanged over N1 between the UE and the SMF device. In response to a request from an application server, the 5GC may trigger a specific application in the UE. In response to receiving that trigger message, the UE may transfer the received message to an application identified in the UE. The identified application may establish a PDU session with respect to a specific DNN.

The SMF device may support a PDU session for a LADN in which an access to a data network is available in a specific LADN service area.

The SMF device may verify whether a UE request is compliant with a user subscription. For this purpose, the SMF device may retrieve and request update notifications on SMF device level subscription data from a UDM. Such data may indicate the following per DNN and, if applicable, per single network slice selection assistance information (S-NSSAI) i) allowed PDU session types and a default PDU session type; ii) allowed SSC modes and a default SSC mode; iii) QoS information, such as subscribed session-AMBR, default 5QI and default ARP; and iv) a static IP address/prefix.

The UE that is registered over multiple accesses selects an access used to establish a corresponding PDU session. An HPLMN may send a policy to the UE to guide the UE selection of the access over which to establish the corresponding PDU session.

The UE may request to move a PDU session between the 3GPP access and the non-3GPP access. A determination to move the PDU session between the 3GPP access and the non-3GPP access is made based on a PDU session unit. That is, the UE may have some PDU sessions using the 3GPP access at a given time, while other PDU sessions are using the non-3GPP access.

In a PDU session establishment request sent to the network, the UE may provide a PDU session identifier (ID). The PDU session ID is unique per UE and is used to uniquely identify a single PDU session from among PDU sessions of the UE. The PDU session ID may be stored in the UDM to support a handover between the 3GPP access and the non-3GPP access. The UE may also provide i) a PDU session type; ii)S-NSSAI; iii) a DNN; and iv) an SSC mode.

The UE may establish a plurality of PDU sessions in the same data network or different data networks, through 3GPP and non-3GPP access networks at the same time.

The UE may establish the plurality of PDU sessions in the same data network and may be served by a different UPF device that terminates N6.

The UE with the established plurality of PDU sessions may be served by a different SMF device.

The SMF device may be registered and deregistered based on a unit of a PDU session granularity in the UDM.

User plane paths of different PDU sessions (to the same or to different DNNs) belonging to the same UE may be completely disjointed between the AN and the UPF device interfacing with the DN.

<Interaction Between AMF Device and SMF Device>

The AMF device and the SMF device are separate network functions.

N1 related interaction with the SMF device is as follows:

i) A single N1 termination point is located in the AMF device. The AMF device forwards SM related NAS information to the SMF device based on a PDU session ID of a NAS message. Also, SM NAS exchanges (e.g., SM NAS message responses) for N1 NAS signaling received by the AMF device over an access (e.g., the 3GPP access or the non-3GPP access) are transported over the same access. ii) A serving PLMN ensures that subsequent SM NAS exchanges (e.g., SM NAS message responses) for N1 NAS signaling received by the AMF device over an access (e.g., the 3GPP access or the non-3GPP access) are transported over the same access. iii) The SMF device handles a session management part of NAS signaling exchanged with the UE. iv) The UE may initiate a PDU session establishment in an RM-REGISTERED state. v) In response to the SMF device being selected to serve a specific PDU session, the AMF device needs to ensure that all NAS signaling related within the specific PDU session is handled by the same SMF device instance. vi) In response to a successful PDU session establishment, the AMF device and the SMF device store an access type with which the PDU session is associated.

N11 related interaction with the SMF device is as follows:

i) The AMF device reports a reachability of the UE based on a subscription from the SMF device, including UE location information with respect to an area of interest indicated by the SMF device. ii) The SMF device indicates to the AMF device when a PDU session is released; iii) In response to a successful PDU session establishment, the AMF device stores an identifier of a serving SMF device of the UE and the SMF device stores an identifier of a serving AMF device of the UE including an AMF device set. When attempting to reach the AMF device serving the UE, the SMF device may need to apply a behavior described in “the other CP NFs.”

N2 related interaction with the SMF device is as follows:

i) Some N2 signaling (e.g., handover related signaling) may require an action of the AMF device and the SMF device. In this case, the AMF device needs to ensure coordination between the AMF device and the SMF device. The AMF device may forward SM N2 signaling towards the corresponding SMF device based on the PDU session ID in N2 signaling. ii) The SMF device may provide the PDU session type and the PDU session ID to NG-RAN to facilitate the NG-RAN to apply a suitable header compression mechanism to a packet of a different PDU type.

N3 related interaction with the SMF device is as follows:

i) Selective activation and deactivation of UP connection of an existing PDU session is defined.

N4 related interaction with the SMF device is as follows:

i) When the UPF device is aware of arrival of some DL data for the UE without downlink N3 tunnel information, the SMF device interacts with the AMF device to initiate Network triggered service request procedure. In this case, if the SMF device is aware that the UE is unreachable or if the UE is reachable only for a regulatory prioritized service and the PDU session is not for the regulatory prioritized service, the SMF device does not inform DL data notification to the AMF device.

The AMF device may select the SMF device per procedure. For this purpose, the AMF device may acquire subscription data from the UDM. Also, the AMF device may retrieve the subscribed UE-AMBR from the UDM and may send the retrieved UE-AMBR to the (R)AN.

The interaction between the AMF device and the SMF device to support the LADN is defined as follows:

To support charging data collection and to fulfill regulatory requirements (to provide network provided location information (NPLI)) related with set-up, modification, and release of IMS voice calls or with SMS device transfer, the following applies:

i) At the time of PDU session establishment, the AMF device provides the SMF device with a PEI of the UE if the PEI is available at the AMF device; Alternatively, ii) when forwarding UL NAS or N2 signaling to a peer NF (e.g., to the SMF device or SMSF) or during UP connection activation of a PDU session, the AMF device provides user location information received from the 5G-AN, an access type (3GPP or non-3GPP) of the AN over which the UL NAS or N2 signaling is received, and a corresponding UE time zone.

The User Location information, the access type, and the UE time zone may be further provided from the SMF device to the PCF. The PCF may acquire information from the SMF device to provide NPLI to an application (e.g., IMS) that requests the information.

The user location information may correspond to the following:

i) In the case of NG-RAN: Cell-Id. ii) In the case of N3IWF: UE local IP address (used to reach the N3IWF) and optionally UDP or TCP source port number (if NAT is detected).

<Single PDU Session with Plurality of PDU Session Anchors>

To support selective traffic routing to the DN or SSC mode 3, the SMF device may control a data path of a PDU session so that the PDU session may simultaneously correspond to a plurality of N6 interfaces. The UPF device may terminate the plurality of N6 interfaces to support PDU session anchor functionality. Each PDU session anchor supporting a PDU session provides a different access to the same DN. Also, the PDU session anchor assigned at the establishment of the PDU session is associated with an SSC mode of the PDU session. Additional PDU session anchors assigned within the same PDU session, for example, for selective traffic routing to the DN, are independent of the SSC mode of the PDU session.

Selective traffic routing to the DN supports, for example, deployments in which some selected traffic is forwarded on an N6 interface to the DN that is close to an access network serving the UE.

The following two schemes may be used for processing the PDU session:

(1) usage of a UL classifier functionality for a PDU session as shown in FIGS. 5; and

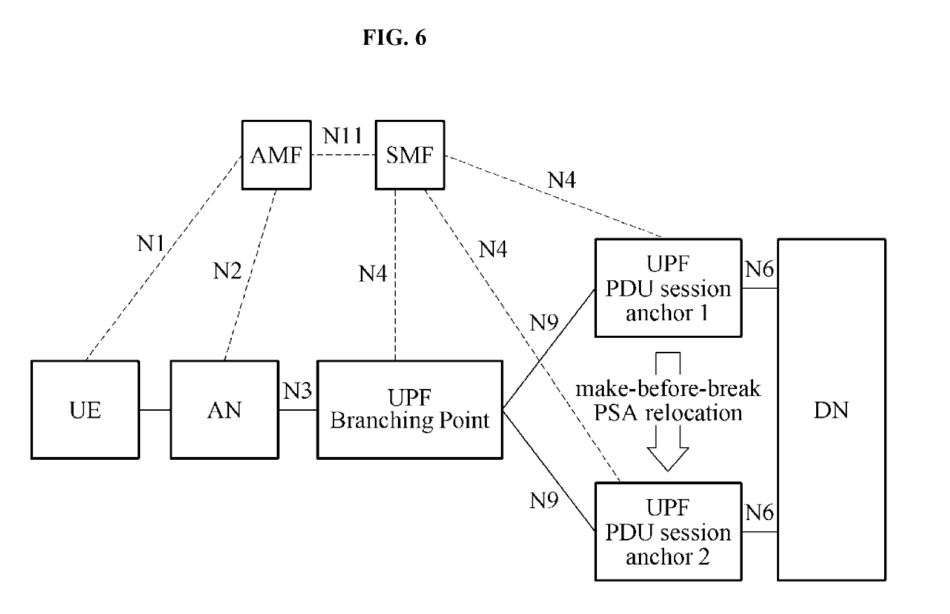

(2) usage of an IPv6 multi-homing for a PDU session as shown in FIGS. 6 and 7.

<Usage of UP Classifier for PDU Session>

FIG. 5 illustrates an example of a user plane (UP) architecture of an uplink classifier according to an example embodiment.

Referring to FIG. 5, in PDU sessions of IPv4, IPv6, or Ethernet, an SMF device may insert a uplink classifier (UL CL) in a data path of a PDU session. Inserting the UL CL indicates inserting a UPF device corresponding to the UL CL in a data path from a UE to a data network (DN) in a 5G core network. The SMF device may determine to insert a UPF device supporting a UL CL functionality in a data path of the PDU session during or after PDU session establishment, or to remove the UPF device supporting the UL CL functionality from the data path of the PDU session after the PDU session establishment. The SMF device may include at least one UPF device supporting the UL CL functionality in the data path of the PDU session. The UL CL is a functionality supported by the UPF that aims at diverting (locally) some traffic matching traffic filters provided from the SMF device. Insertion and removal of the UL CL is determined or controlled by the SMF device using generic N4 and UPF capabilities. The SMF device includes at least one UPF device supporting the UL CL functionality in the data path of the PDU session.

The UE is unaware of traffic diversion by the UL CL. The UE does not involve in both the insertion and the removal of the UL CL. In a PDU session of IPv4 or IPv6 type, the UE associates the PDU session with either a single IPv4 address or a single IPv6 prefix allocated by the network.

When the UL CL functionality is inserted in the data path of the PDU session, there are a plurality of PDU session anchors for the PDU session. Each of the PDU session anchors provides a different access to the same DN. In the PDU session of the IPv4 or IPv6 type, only a single PDU session anchor is an IP anchor point for the IPv4 address/IPv6 prefix of the PDU session provided to the UE.

The UL CL provides forwarding of UL traffic towards different PDU session anchors. The UL CL merges DL traffic towards the UE. Here, traffic from different PDU session anchors is merged on a link towards the UE. Merging of traffic is based on traffic detection and traffic forwarding rules provided from the SMF device.

The UL CL applies a filtering rule and determines how a packet needs to be routed. The filtering rule refers to examining a destination IP address/prefix of UL IP packets sent by the UE. The UPF device supporting the UL CL may be controlled by the SMF device to support traffic measurement for charging, traffic replication for LI, and bit rate enforcement per PDU session AMBR.

The UPF device supporting the UL CL may also support a PDU session anchor for connectivity to a local access to the DN (including, for example, support of tunnelling or NAT on N6). It may be controlled by the SMF device.

Additional UL CLs (and additional PDU session anchors) may be inserted in the data path of the PDU session to create a new data path for the same PDU session. A method of organizing data paths of all UL CLs in the PDU session depends on an operator configuration and an SMF device logic. Only a single UPF device supports the UL CL connecting to the (R)AN through an N3 interface.

The insertion of the UL CL in the data path of the PDU session is shown in FIG. 5.

According to an example embodiment, if the UE in an IDLE state moves to a new registration area, the UE may connect to a network temporarily for registration to a new network in response to a change in a registration area. Here, active traffic may be absent. During registration to the new network, the AMF device and the SMF device may manage a location of the UE and the SMF device may determine control of a UPF device, such as intermediate UPF (I-UPF) insertion, removal, and relocation. Based on the determination, an operation, such as I-UPF insertion, removal, and relocation may be performed in a session idle state. That is, during registration to the new network in the session idle state, the UPF device may be controlled and thus, potential interruption may be reduced when providing an actual service.

According to an example embodiment, in the case of performing I-UPF control, such as I-UPF insertion, removal, and relocation, in a session idle state, control of the UPF device may be performed and interface between a base station and the UPF device may not be updated. Accordingly, signaling load between a RAN and a core network may be reduced by not updating in the session idle state.

According to an example embodiment, relocation of a PDU session anchor (PSA) that is a UPF device serving as an anchor gateway of a corresponding PDU session based on a session may be performed to not fix a 5G network and manage a flexible data path. Also, to support a network in which the base station and the PSA are not directly connected, at least one I-UPF device may be inserted between the base station and the PSA.

<Usage of IPv6 Multi-Homing for PDU Session>

FIG. 6 illustrates an example of a multi-homed PDU session used to support a service continuity according to an example embodiment, and FIG. 7 illustrates an example of a multi-homed PDU session used to support a local access to the same data network according to an example embodiment.

A PDU session may be associated with a plurality of IPv6 prefixes. It is referred to as a multi-homed PDU session. The multi-homed PDU session provides an access to a data network through one or more PDU session anchors. Different user plane paths that lead to different PDU session anchors branch out at a common UPF referred to as a UPF device supporting “branching point functionality.” The branching point forwards UP traffic towards the different PDU session anchors and merges traffic from the different PDU session anchors on a link towards the UE.

The UPF device supporting the branching point functionality may be controlled by the SMF device to support traffic measurement for charging, traffic replication for LI, and bit rate enforcement per PDU session AMBR. Insertion and removal of the UPF device supporting the branching point is determined or controlled by the SMF device using generic N4 and UPF capabilities. The SMF device may determine to insert, in a data path of the PDU session, a UPF device supporting the branching point functionality during or after a PDU session establishment. The SMF device may determine to remove, from the data path of the PDU session, the UPF device supporting the branching point functionality after the PDU session establishment.

Multi-homing of the PDU session may apply for PDU sessions of IPv6 type. A request of PDU session type “IP” or “IPv6” indicates support of a multi-homed PDU session for IPv6 in the UE.

The use of the plurality of IPv6 prefixes in the PDU session may have the following characteristics.

The UPF device supporting the branching point functionality is configured by the SMF device to spread UL traffic between IP anchors based on a source prefix of a PDU. Here, the source prefix of the PDU may be selected by the UE based on routing information and preferences received from the network.

Internet Engineering Task Force (IETF) Request for Comments (RFC) 4191 is used to configure routing information and preferences in the UE to influence a selection of the source prefix. It corresponds to scenario 1 defined in IETF RFC “IPv6 multi-homing without network address translation.” Accordingly, the branching point unaware of routing tables in the data network may be created and a first hop router function in the IP anchors may be maintained.

According to an example embodiment, if a UE in an IDLE state moves to a new registration area, the UE may connect to a network temporarily for registration to a new network in response to a change in a registration area. Here, active traffic may be absent. During registration to the new network, the AMF device and the SMF device may manage a location of the UE and the SMF device may determine control of a UPF device, such as I-UPF insertion, removal, and relocation. Based on the determination, an operation, such as I-UPF insertion, removal, and relocation may be performed in a session idle state. That is, during registration to the new network in the session idle state, the UPF device may be controlled and thus, potential interruption may be reduced when providing an actual service.

According to an example embodiment, in the case of performing I-UPF control, such as I-UPF insertion, removal, and relocation, in a session idle state, control of the UPF device may be performed and interface between a base station and the UPF device may not be updated. Accordingly, signaling load between a RAN and a core network may be reduced by not updating in the session idle state.

According to an example embodiment, relocation of a PDU session anchor (PSA) that is a UPF device serving as an anchor gateway of a corresponding PDU session based on a session may be performed to not fix the 5G network and manage a flexible data path. Also, to support a network in which the base station and the PSA are not directly connected, at least one I-UPF device may be inserted between the base station and the PSA.

<Session and Service Continuity (SSC)>

Support for session and service continuity (SSC) in the 5G system architecture may address various continuity requirements of different applications and services for the UE. The 5G system supports different SSC modes. An SSC mode associated with the PDU session does not change during the lifetime of the PDU session.

i) In SSC mode 1, the network preserves a continuity service provided to the UE. In the PDU session of IPv4 or IPv6 type, an IP address may be preserved. ii) In SSC mode 2, the network may release the connectivity service delivered to the UE and may release the PDU session corresponding to the connectivity service. In the IPv4 or IPv6 type, the network may release IP addresses allocated to the UE. iii) In SSC mode 3, a change to the user plane may be visible to the UE, while the network ensures that no loss of connectivity occurs in the UE. A connection through a new PDU session anchor point may be established before a previous connection is terminated for a better service connectivity. In the IPv4 or IPv6 type, the IP address may not be preserved in the SSC mode 3 when the PDU session anchor changes.

An addition process or a removal process of a PDU session anchor in a PDU session for local access to a DN may be independent from an SSC mode of the PDU session.

<Ssc Mode>

(1) SSC Mode 1

With respect to a PDU session of SSC mode 1, the UPF device acting as the PDU session anchor at establishment of the PDU session may be maintained regardless of access technology (e.g., access type and cells) for the UE to a successful network access.

In the PDU session of the IPv4 or IPv6 type, IP continuity may be supported regardless of a UE mobility event.

Here, when IPv6 multi-homing or a UL CL applies to the PDU session of SSC mode 1 and the network allocates additional PDU session anchors to the PDU session, the additional PDU session anchors may be released or allocated. The UE does not expect that an additional IPv6 prefix is maintained during the lifetime of the PDU session. SSC mode 1 may apply to any PDU session type or any access type.

(2) SSC Mode 2

If a PDU session of SSC mode 2 has a single PDU session anchor, the network may trigger release of the PDU session and may instruct the UE to establish a new PDU session in the same DN immediately. A trigger condition depends on an operator policy, for example, a request from an application function based on a load status. At establishment of the new PDU session, a new UPF device acting as the PDU session anchor may be selected.

On the contrary, if the PDU session of SSC mode 2 has the plurality of PDU session anchors (e.g., in the case of a multi-homed PDU session or if a UL CL applies to the PDU session of SSC mode 2), additional PDU session anchors may be released or allocated.

SSC mode 2 may apply to any PDU session type and any access type. In a UL CL mode, the UE may not be involved in PDU session anchor reallocation so that existence of the plurality of PDU session anchors is not visible to the UE.

(3) SSC Mode 3

With respect to a PDU session of SSC mode 3, the network allows establishment of UE connectivity through a new PDU session anchor in the same data network (DN) before connectivity between the UE and a previous PDU session anchor is released. If the trigger condition applies, the network may determine whether to select a PDU session anchor UPF suitable for the new condition of the UE (e.g., a point of attachment to the network).

SSC mode 3 may apply to any PDU session type or any access type.

With respect to a PDU session of IPv4 or IPv6 type, during a change procedure of the PDU session anchor, the following applies:

i) A new IP prefix anchored on the new PDU session anchor may be allocated within the same PDU session based on IPv6 multi-homing. ii) Alternatively, a new IP address or the new IP prefix may be allocated within the new PDU session that the UE is triggered to establish.

After the new IP address or the new IP prefix is allocated, an old IP address or an old IP prefix is maintained during a specific time indicated to the UE and then released.

If the PDU session of SSC mode 3 has the plurality of PDU session anchors (e.g., in the case of multi-homed PDU sessions, or if a UL CL applies to the PDU session of SSC mode 3, the additional PDU session anchors may be released or allocated.

<SSC Mode Selection>

An SSC mode selection policy is used to i) determine a type of a session or ii) determine a type of an SSC mode associated with an application or a group of applications for the UE.

An operator may provide the SSC mode selection policy to the UE. The SSC mode selection policy includes one or more SSC mode selection policy rules that may be used by the UE to determine the type of the SSC mode associated with the application or the group of applications. The SSC mode selection policy may include a default SSC mode selection policy rule that matches all applications of the UE.

When an application requests a data transmission (e.g., opens a network socket) and, here, the application does not specify a required SSC mode, the UE may select the SSC mode associated with the application based on the SSC mode selection policy. In addition, the following behaviors apply to the UE and the network:

a) If the UE already has an established PDU session that matches the SSC mode associated with the application, the UE may route data of the application within the established PDU session unless the UE permits the use of the established PDU session. On the contrary, if the UE does not have the established PDU session that matches the SSC mode associated with the application, the UE may request establishment of a new PDU session that matches the SSC mode associated with the application.

b) The SSC mode associated with the application is either an SSC mode included in a non-default SSC mode selection policy rule that matches the application or an SSC mode included in a default SSC mode selection policy rule, if present. If the SSC mode selection policy does not include the default mode selection policy rule and no other SSC mode selection policy rules match the application, the UE may request the PDU session without providing the SSC mode. In this case, the network may determine the SSC mode of the PDU session.

The SSC mode selection policy rule provided to the UE may be updated by the operator.

The SMF device may receive a list of SSC modes and a default SSC mode per DNN per S-NSSAI as a portion of subscription information from a unified data management (UDM) device.

If the UE provides an SSC mode when requesting a new PDU session, the SMF device may select the SSC mode by accepting the requested SSC mode or by modifying the requested SSC mode based on subscription and/or local configuration.

If the UE does not provide the SSC mode when requesting the new PDU session, the SMF device may select the default SSC mode for a data network listed in the subscription or may apply the local configuration to select the SSC mode.

When a static IP address/IP prefix is allocated to the PDU session, SSC mode 1 may be allocated to the PDU session based on static IP address/IP prefix subscription for the DNN and single network slice selection assistance information (S-NSSAI).

<Description of Network Functions: AMF Device>

The AMF device may perform the following functionalities. A portion or all of the functionalities of the AMF device may be supported in a single instance of the AMF device:

1) Termination of a RAN CP interface (N2); 2) termination of NAS (N1), NAS ciphering and integrity protection; 3) registration management; 4) connection management; 5) reachability management; 6) mobility management; 7) lawful intercept (for AMF device events and an interface to LI system); 8) sending of SM messages between the UE and the SMF device; 9) transparent proxy for routing SM messages; 10) access authentication; 11) access authorization; 12) sending of SMS messages between the UE and SMSF; 13) security anchor functionality (SEAF) that interacts with the AUSF and the UE, receives an intermediate key established as a result of a UE authentication process, and enables the AMF device to retrieve a security material from the AUSF in the case of a USIM-based authentication; 14) security context management (SCM) that receives, from the SEAF, a key used to derive an access-network specific key; 15) location service management for regulatory services; 16) sending of location service messages between the UE and the LMF as well as between the RAN and the LMF; and 17) EPS bearer ID allocation for interworking with EPS.

Regardless of a number of network functions, a single NAS interface instance is present per access network between the UE and the CN and is terminated at one of the network functions that implement at least NAS security and mobility management.

In addition to the aforementioned functionalities of the AMF device, the AMF device may include the following functionalities to support a non-3GPP access network:

i) Support of an N2 interface with N3IWF: Through this interface, a portion of information (e.g., 3GPP cell identification) and procedures (e.g., a handover related procedure) defined over the 3GPP access may not be applied and non-3GPP access specific information that does not apply to the 3GPP access may be applied. ii) Support of NAS signaling with the UE over N3IWF: A portion of procedures supported by NAS signaling over the 3GPP access may not be applied to an untrusted non-3GPP (e.g., paging) access. iii) Support of authentication of UEs connected over N3IWF. iv) Management of mobility, authentication, and a separate security context state of the UE connected over the 3GPP access and or simultaneously connected over 3GPP and non-3GPP accesses. v) Support of a coordinated RM management context over the 3GPP and non-3GPP accesses. vi) Support of a dedicated CM management context for the UE for connectivity over the non-3GPP access.

<Description of Network Functions: SMF Device>

The SMF device may perform the following functionalities. A portion or all of the functionalities of the SMF device may be supported in a single instance of the SMF device:

i) The SMF device may perform a session management, for example, establishment, modification, and release of a session, including a tunnel maintained between the UPF device and an AN node. ii) The SMF device may perform a UE IP address allocation and management (including optional authorization). iii) The SMF device may perform DHCPv4 (server and client) and DHCPv6 (server and client) functions. iv) The SMF device may perform ARP proxying specified in IETF RFC 1027 and/or IPv6 neighbor solicitation proxying specified in IETF RFC 4861 functionality for Ethernet PDUs. The SMF device may respond to the ARP and/or IPv6 neighbor solicitation request by providing a MAC address corresponding to an IP address sent in the request. v) The SMF device may perform a selection and a control of a UP function, including controlling the UPF device to a proxy ARP or IPv6 neighbor discovery, or to forward all of ARP/IPv6 neighbor solicitation traffic to the SMF device, for Ethernet PDU sessions. vi) The SMF device may configure traffic steering at the UPF device to route traffic to a proper destination. The SMF device may terminate interfaces towards policy control functions. The SMF device may perform lawful intercept (SM events and an interface to LI system). vii) The SMF device may perform charging data collection and support of charging interfaces. The SMF device may perform control and coordination of the charging data collection at the UPF device. The SMF device may perform termination of SM parts of NAS messages. The SMF device may perform a downlink data notification. The SMF device may be an initiator of AN specific SM information that is sent through the AMF device over N2 to the AN. The SMF device may determine an SSC mode of a session. viii) The SMF device may perform a roaming functionality, for example, (1) handling of local enforcement to apply QoS SLAB (VPLMN), (2) charging data collection and charging intercept (VPLMN), (3) lawful intercept (in VPLMN for SM events and the interface to LI system), and (4) support for interaction with an external DN for transport of signaling for PDU session authentication/authorization by the external DN.

Not all of the functionalities are required to be supported in an instance of a Network slice.

<Description of Network Functions: UPF Device>

The UPF device may perform the following functionalities. A portion or all of the functionalities of the UPF device may be supported in a single instance of the UPF device:

i) If applicable, the UPF device may perform a function of an anchor point for intra-/inter-RAT mobility. The UPF device may perform a function of an external PDU session point of interconnection to a data network. ii) The UPF device may perform packet routing and forwarding. For example, the UPF device may support a UP CL to route traffic flows to an instance of the data network and may support a branching point to support a multi-homed PDU session. iii) The UPF device may perform a packet inspection. For example, the UPF device may perform an application detection based on a service data flow template and optical PDFs additionally received from the SMF device. iv) The UPF device may perform a user plane part of policy rule enforcement, for example, grating, redirection, and traffic steering. The UPF device perform lawful intercept (UP collection). The UPF device may perform traffic usage reporting. The UPF device may perform QoS handling for a user plane, for example, UL/DL rate enforcement and reflective QoS marking in a DL. The UPF device may perform uplink traffic verification (SDF device to QoS flow mapping). The UPF device may perform datalink packet buffering and downlink data notification triggering. The UPF device may send and forward at least one “end marker” to a source NG-RAN node. v) The UPF device may perform ARP proxying specified in IETF RFC 1027 and/or IPv6 neighbor solicitation proxying specified in IETF RFC 4861 functionality for Ethernet PDUs. The UPF device may respond to an ARP and/or IPv6 neighbor solicitation request by providing a MAC address corresponding to an IP address sent in the request.

Not all of the UPF functionalities are required to be supported in an instance of a user plane function of a network slice.

<System Procedures>

<General>

Hereinafter, procedures and network function services for a communication system according to example embodiments by end-to-end information flows are described. The information flows may use NF service operations for communication within a 5GC control plane.

### <Connection, Registration, and Mobility Management Procedures>

### <General>

The connection management may be used to establish and release a control plane signaling connection between the UE and the AMF device. The registration management may be used to register or deregister the UE/user to or from the communication system. The mobility management may be used to continuously track a current location of the UE. The communication system according to example embodiments may provide the following connection, registration, and mobility management functionality.

<N4 Session Management Procedures>

The N4 session management procedures are used to control the functionality of the UPF device. The SMF device may create, update, and remove an N4 session context in the UPF device. The N4 session management procedures, that is, N4 session establishment procedure, N4 session modification procedure, and N4 session release procedure, are initiated by the SMF device:

1. N4 Session Establishment Procedure

The N4 session establishment procedure is used to create an initial N4 session context for a PDU session at the UPF device. The SMF device assigns a new N4 session ID and provides the assigned new N4 session ID to the UPF device. The N4 session ID is stored in the SMF device and the UPF device and used to identify the N4 session context during an interaction between the SMF device and the UPF device. Also, the SMF device stores a relationship between the N4 session ID and the PDU session for the UE.

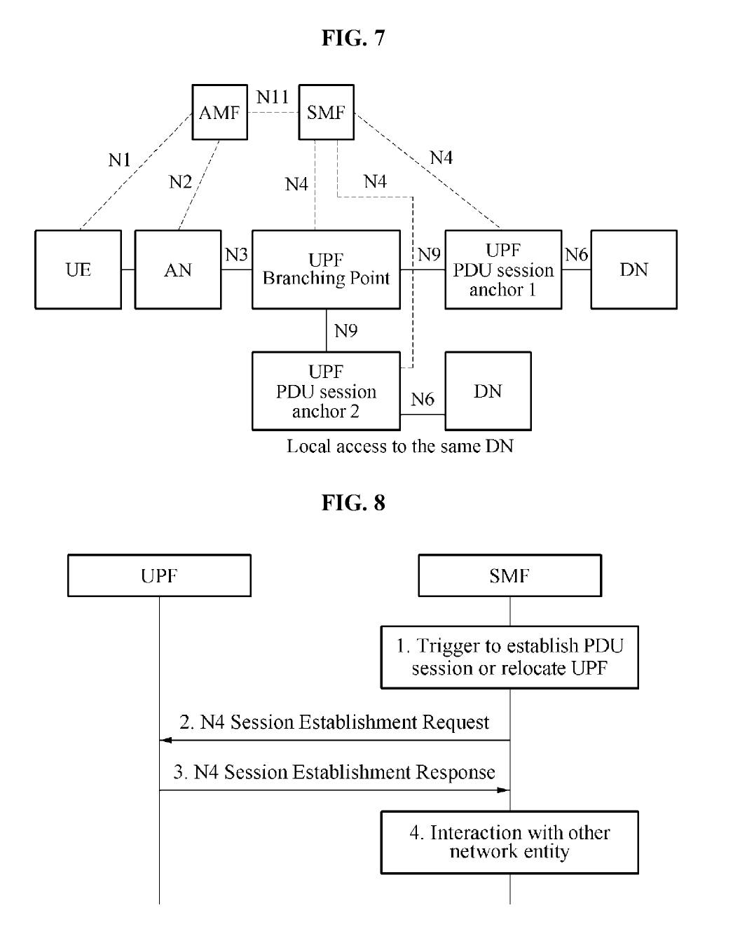

FIG. 8 illustrates an example of the N4 session establishment procedure according to an example embodiment.

Referring to FIG. 8, in operation 1, the SMF device receives a trigger to establish a new PDU session or change, for example, relocate the UPF device for an established PDU session.

In operation 2, the SMF device sends an N4 session establishment request message to the UPF device, including structured control information used to define how the UPF device needs to behave.

In operation 3, the UPF device responds with an N4 session establishment response message including information that the UPF device needs to provide to the SMF device in response to the received control information.

In operation 4, the SMF device interacts with a network entity that triggers the N4 session establishment procedure.

2. N4 Session Modification Procedure

The N4 session modification procedure is used to update an N4 session context of an existing PDU session at the UPF device, which is executed between the SMF device and the UPF device every time PDU session related parameters need to be modified.

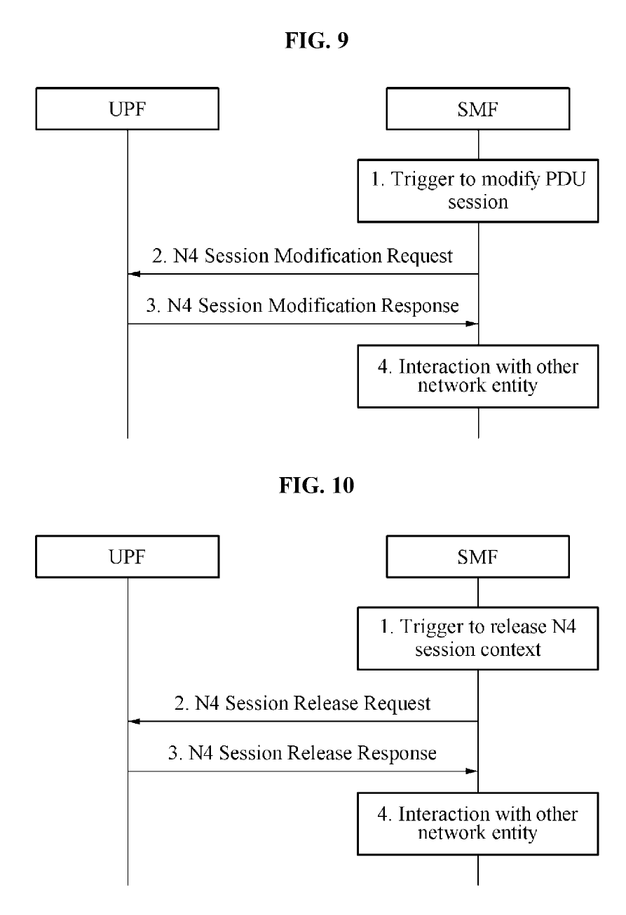

FIG. 9 illustrates an example of the N4 session modification procedure according to an example embodiment.

Referring to FIG. 9, in operation 1, the SMF device receives a trigger to modify the existing PDU session.

In operation 2, the SMF device sends an N4 session modification request message to the UPF device, including update for structured control information used to define how the UPF device needs to behave.

In operation 3, the UPF device identifies the N4 session context to be modified based on an N4 session ID and updates parameters of the N4 session context based on a list of parameters sent from the SMF device. The UPF device responds with an N4 session modification response message including information that the UPF device needs to provide to the SMF device in response to the received control information.

In operation 4, the SMF device interacts with a network entity (e.g., AMF or PCF) that triggers the N4 session modification procedure.

3. N4 Session Release Procedure

The N4 session release procedure is used to remove an N4 session context of an existing PDU session at the UPF device.

FIG. 10 illustrates an example of the N4 session release procedure according to an example embodiment.

Referring to FIG. 10, in operation 1, the SMF device receives a trigger to release an N4 session context for the existing PDU session.

In operation 2, the SMF device sends an N4 session release request message to the UPF device.

In operation 3, the UPF device identifies the N4 session context to be removed based on an N4 session ID and removes the entire session context. The UPF device responds with an N4 release response message including information that the UPF device needs to provide to the SMF device.

In operation 4, the SMF device interacts with a network entity (e.g., AMF or PCF) that triggers the N4 session release procedure.

<Registration Management Procedures>

<General>

The UE needs to register with a network to be authorized to receive services and to enable mobility tracking and reachability.

The registration procedure may be used when the UE needs to perform an initial registration to the communication system according to example embodiments or to perform a mobility registration update in response to changing to a new tracking area (TA) outside a registration area of the UE in both a CM_CONNECTED mode and a CM_IDLE mode, when the UE performs a periodic registration update (due to a predefined time period of inactivity), and additionally when the UE needs to update capabilities or protocol parameters of the UE that are negotiated in the registration procedure.

Although the following general registration call flow may apply to all of the registration procedures, the periodic registration does not need to include all parameters that are used in other registration cases.

The following general registration call flow may be used for emergency registration by UEs required to perform emergency services, however, incapable of receiving normal services from the network. The UEs may be in a limited service state defined in TS 23.122.

During the initial registration, a peripheral equipment interface (PEI) may be acquired from the UE. An operator of the AMF device may verify the PEI with an equipment identity register (EIR). The AMF device may transfer the PEI (IMEISV) to the UDM device, and to the SMF device and the PCF device. The UDM device may store data in a UDR device by Nudr_SDM_Update. An NSI ID may be optionally used in the communication system and may depend on a deployment selection of the operator.

<General Registration>

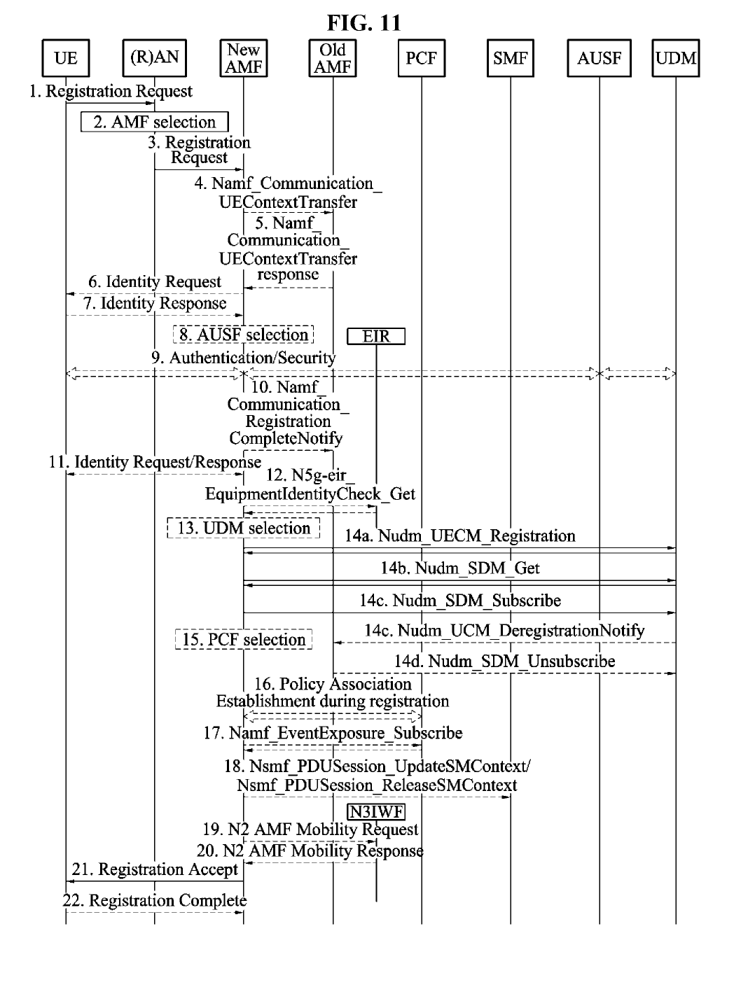

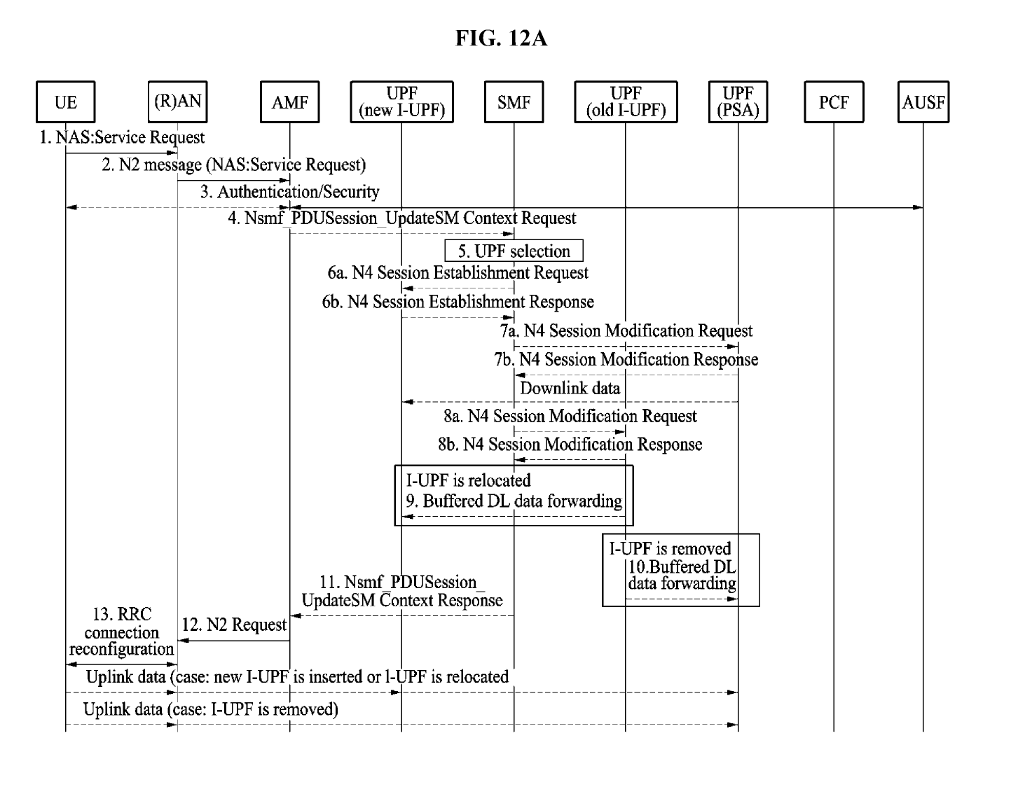

FIG. 11 illustrates an example of a UE registration procedure in a communication system according to an example embodiment.

Referring to FIG. 11, in operation 1, the UE may send, to the (R)AN, an AN message (AN parameters, RM-NAS registration request (registration type, subscription concealed identifier (SUCI), SUPI or 5G-GUTI, last visited TAI (if available), security parameters, requested NSSAI, mapping of requested NSSAI, UE 5GC capability, PDU session status, PDU session(s) to be re-activated, follow-on request, and MICO mode preference).

In the case of NG-RAN, the AN parameters may include, for example, the SUCI, the SUPI or the 5G-GUTI, a selected PLMN ID, and the requested NSSAI. The AN parameters may include an establishment cause. The establishment cause may provide a reason for requesting establishment of an RRC connection.

The registration type may indicate whether the UE desires to perform an initial registration (i.e., the UE is in an RM-DEREGISTERED state), a mobility registration update (i.e., the UE is in an RM-REGISTERED state and initiates a registration procedure due to mobility), a periodic registration update (i.e., the UE is in the RM-REGISTERED state and initiates the registration procedure due to expiry of a periodic registration update timer) or an emergency registration (i.e., the UE is in a limited service state). The UE may perform the initial registration (i.e., the UE is in the RM-DEREGISTERED state) to a PLMN for which the UE does not have the 5G-GUTI. The UE may include the SUCI or SUPI of the UE in the registration request. The SUCI may be included only if a home network provides a public key to protect the SUPI in the UE. If a UE configuration update command indicating that the UE needs to re-register and the 5G-GUTI is invalid is received at the UE, the UE may perform the initial registration and may include the SUPI in the registration request message. For the emergency registration, the SUPI may be included if the UE does not have the SUPI and a valid 5G-GUTI SUPI. A PEI may be included when the UE does not have the SUPI and the valid 5G-GUTI SUPI. In other cases, the 5G-GUTI may be included and may indicate a last serving AMF device. If the UE is already registered over the non-3GPP access in a PLMN different from the new PLMN (i.e., not the registered PLMN or an equivalent PLMN of the registered PLMN) of the 3GPP access, the UE may not provide, over the 3GPP access, the 5G-GUTI allocated by the AMF device during the registration procedure over the non-3GPP access. Also, if the UE is already registered over the 3GPP access in the PLMN (i.e., the registered PLMN), different from the new PLMN (i.e., not the registered PLMN or the equivalent PLMN of the registered PLMN) of the non-3GPP access, the UE may not provide, over the non-3GPP access, the 5G-GUTI allocated by the AMF during the registration procedure over the 3GPP access. The UE may provide a usage setting of the UE based on the configuration of the UE. In the case of the initial registration or the mobility registration update, the UE may include mapping of the requested NSSAI, which is mapping of each S-NSSAI of the requested NSSAI to the S-NSSAI of the configured NSSAI for the HPLMN, to ensure that the network is able to verify whether the S-NSSAI(s) in the requested NSSAI are permitted based on the subscribed S-NSSAI.

If available, the last visited TAI may be included to help the AMF procedure registration area for the UE.

The security parameters may be used for authentication and integrity protection. The requested NSSAI represents network slice selection assistance information. The PDU session status indicates previously established PDU sessions in the UE. When the UE is connected to two AMF devices belonging to different PLMNs over the 3GPP access and the non-3GPP access, the PDU session state indicates an established PDU session of a current PLMN in the UE. PDU session(s) to be re-activated may be included to indicate the PDU session(s) for which the UE intends to activate UP connections. A PDU session corresponding to a LADN may not be included in the PDU session(s) to be re-activated corresponding to the LADN when the UE is outside an area in which the LADN is available. The follow-on request may be included when the UE has pending uplink signaling and does not include PDU session(s) to be re-activated, or when the registration type indicates that the UE desires to perform the emergency registration. HO attach indication may be added.

In operation 2, if the SUPI is included or if the 5G-GUTI does not indicate the valid AMF device, the (R)AN may select the AMF device based on the (R)AT and requested NSSAI.

The (R)AN may select the AMF device. If the UE is in a CM-CONNECTED state, the (R)AN may forward a registration request message to the AMF device based on an N2 connection of the UE. If the (R)AN is incapable of selecting an appropriate AMF device, the (R)AN may forward, to the AMF device, a registration request that is configured in the (R)AN to perform AMF device selection.

In operation 3, the (R)AN may send, to a new AMF device, an N2 message (N2 parameters, RM-NAS registration request (registration type, SUPI or 5G-GUTI, last visited TAI (if available), security parameters, requested NSSAI, mapping of requested NSSAI, UE 5GC capability, PDU session status, PDU session(s) to be re-activated, follow-on request, and MICO mode preference)).

When the NG-RAN is used, the N2 parameters may include a selected PLMN ID, location information, a cell identity and a RAT type related to a cell in which the UE is camping. When the NG-RAN is used, the N2 parameters may also include an establishment cause. If the registration type indicated by the UE is periodic registration update, operations 4 to 17 may be omitted.

In operation 4 that is conditionally performed, the new AMF device may send Namf_Communication_UEContextTransfer (complete registration request) to an old AMF device.

If the 5G-GUTI of the UE is included in the registration request and a serving AMF device is changed since a last registration procedure, the new AMF device may invoke an Namf_Communication_UEContextTransfer service operation on the old AMF device, including a complete registration request IE, which may be integrity protected, to request the SUPI and MM context of the UE. The old AMF device may use the integrity protected complete registration request IE to verify whether a context transfer service operation invocation corresponding to the UE is requested.

The old AMF device may transfer event subscription information by each NF consumer, for the UE, to the new AMF device. Once the UE is successfully registered with the new AMF device, the NF consumers do not need to subscribe for an event once again with the new AMF device.

If the new AMF device has already received UE contexts from the old AMF device during a handover procedure, operations 4,5 and 10 may be omitted.

For the emergency registration, if the UE identifies the UE itself with a 5G-GUTI that is not known to the AMF device, operations 4 and 5 may be omitted. The AMF device may immediately request the UE for the SUPI. If the UE identifies the UE itself with the PEI, the SUPI request may be omitted. Allowing the emergency registration without a user identity may depend on local regulations.

In operation 5 that is conditionally performed, the old AMF device may send a response to Namf_Communication_UEContextTransfer (SUPI, MM context, SMF information, PCF ID) to the new AMF device.

The old AMF device may respond to the new AMF device for the Namf_Communication_UEContextTransfer invocation by including the SUPI and the MM context of the UE.

If the old AMF device holds information about established PDU sessions, the old AMF device may include SMF information including S-NSSAI(s), SMF identities and PDU session ID. If the old AMF device holds information about active NGAP UE-TNLA bindings to N3IWF, the old AMF device may include information about the NGAP UE-TNLA bindings.

In operation 6 that is conditionally performed, an identity request may be sent from the new AMF device to the UE device. If the SUPI is not provided from the UE or not retrieved from the old AMF device, an identity request procedure may be initiated in such a manner that the AMF device sends an identity request message to the UE requesting the SUCI.

In operation 7 that is conditionally performed, an identity response may be sent from the UE to the new AMF device. The UE may respond with an identity response message including the SUCI. The UE may derive the SUCI using a provisioned specific public key of the HPLMN.

In operation 8, the AMF device may determine to initiate UE authentication by invoking an AUSF. In this case, the AMF device may select the AUSF based on the SUPI or the SUCI.

If the AMF device is configured to support the emergency registration for unauthenticated SUPIs and the UE indicated registration type emergency registration, the AMF device may skip the authentication and security setup. Alternatively, the AMF device may accept that the authentication may fail, and may continue the registration procedure.

In operation 9, the AUSF device may execute authentication of the UE.

The authentication may be performed as described by the Nudm_UEAuthenticate_Get operation. The AUSF device may discover a UDM. When the AMF device provides the SUCI to the AUSF device, the AUSF device may return the SUPI to the AMF device after the authentication succeeds.

If network slicing is used, the AMF device may determine whether the registration request in which the initial AMF device refers to the AMF device needs to be rerouted.

Also, in operation 9, the AMF device may initiate NAS security functions.

Also, in operation 9, once the NAS security function setup is completed, the AMF device may initiate an NGAP procedure so that 5G-AN may use it for security procedures with the UE.

Also, in operation 9, the 5G-AN may store the security context and may make acknowledgment to the AMF device. The 5G-AN may use the security context to protect the messages exchanged with the UE.

In operation 10 that is conditionally performed, the new AMF device may send Namf_Communication_RegistrationCompleteNotify to the old AMF device.

If the AMF device is changed, the new AMF device may notify the old AMF that the registration of the UE in the new AMF device is completed by invoking an Namf_Communication_RegistrationCompleteNotify service operation.

If the authentication/security procedure fails, the registration may be rejected, and the new AMF device may invoke the Namf_Communication_RegistrationCompleteNotify service operation with a reject indication reason code towards the old AMF device. The old AMF device may continue as if the UE context transfer service operation is not received.

If at least one of the S-NSSAI used in the old registration area may not be served in a target registration area, the new AMF device may determine which PDU session may not be supported in the new registration area. The new AMF device may invoke the Namf_Communication_RegistrationCompleteNotify service operation including the rejected PDU session ID and a reject cause (e.g., the S-NSSAI becomes no longer available) towards the old AMF device. In this case, the new AMF device may modify the PDU session status correspondingly. The old AMF device may inform corresponding SMF(s) to locally release the SM context of the UE by invoking the Nsmf PDUSession_ReleaseSMContext service operation.

In operation 11 that is conditionally performed, an identity request/response (PEI) may be sent from the new AMF device to the UE.

If the PEI is not provided from the UE or not retrieved from the old AMF device, the identity request procedure may be initiated by the AMF device sending an identity request message to the UE to retrieve the PEI. The PEI may be encrypted and thereby transferred unless the UE performs emergency registration and may not be authenticated.

For the emergency registration, the UE may include the PEI in the registration request. In this case, the PEI retrieval may be omitted.

In operation 12, the new AMF device may initiate a ME identity check by invoking the N5g-eir_EquipmentIdentityCheck_Get service operation. For the emergency registration, if the PEI is blocked, operator policies may be used to determine whether to continue or stop the emergency registration procedure.

If operation 14 is to be performed, the new AMF device may select a UDM device based on the SUPT in operation 13. In this case, the UDM may select a UDR instance.

In operations 14a and 14b, if the AMF device is changed since the last registration procedure, if the UE provides a SUPT that does not refer to a valid context in the AMF device, or if the UE registers to the same AMF device that is already registered to the non-3GPP access (i.e., the UE is registered over the non-3GPP access and initiates this registration procedure to add the 3GPP access), the new AMF device may register with the UDM device using Nudm_UECM_Registration and may subscribe to be notified when the UDM device deregisters this AMF device. The UDM device may store an AMF identity associated with an access type and may not remove the AMF identity associated with another access type. UDM device may store information provided at registration in UDR, by Nudr_UDM_Update.

The AMF device may retrieve access and mobility subscription data and SMF selection subscription data using Nudm_SDM_Get. This requires that the UDM device may retrieve this information from the UDR by Nudr_UDM_Query (access and mobility subscription data). After a successful response is received, the AMF device may subscribe to be notified using Nudm_SDM_Subscribe when the data requested is modified and the UDM may subscribe to UDR by Nudr_UDM_Subscribe. The GPSI may be provided to the AMF device in the subscription data from the UDM device if the GPSI is available in the UE subscription data.

The new AMF device may provide the UDM device with the access type the new AMF device serves for the UE. Here, the access type may be set to “3GPP access.” The UDM device may store the associated access type together with the serving AMF device in UDR by Nudr_UDM_Update.

The new AMF device may create an MM context for the UE after acquiring the mobility subscription data from the UDM device. For the emergency registration in which the UE is not successfully authenticated, the AMF device may not register with the UDM device. For the emergency registration, the AMF device may not verify access restrictions, regional restrictions, or subscription restrictions. For the emergency registration, the AMF device may ignore an unsuccessful registration response from the UDM device and continue with the registration procedure.

In operation 14c, when the UDM device stores the associated access type together with the serving AMF device as indicated in operation 14a, it may cause the UDM device to initiate Nudm_UECM_DeregistrationNotification to the old AMF device corresponding to the 3GPP access, if one exists. The old AMF device may remove the MM context of the UE. If a serving NF removal reason indicated by the UDM device is initial registration, the old AMF may invoke an Namf EventExposure_Notify service operation towards all the associated SMF devices of the UE to notify that the UE is deregistered from the old AMF device. The SMF device may release the PDU session(s) in response to receiving the notification.

In operation 14d, the old AMF device may cancel subscription to, that is, unsubscribe from the UDM device for subscription data using Nudm_SDM_unsubscribe.

In operation 15, if the AMF device determines to initiate PCF communication, for example, if the AMF device has not yet acquired an access and mobility policy for the UE or if the access and mobility policy in the AMF device is no longer valid, the AMF device may select a PCF device. If the new AMF device receives a PCF ID from the old AMF device in operation 5 and successfully contacts with the PCF device identified based on the PCF ID, the AMF device may select the (V-)PCF identified based on the PCF ID. If the PCF device identified by the PCF ID is unavailable (e.g., no response from the PCF device) or if there is no PCF ID received from the old AMF device in operation 5, the AMF device may select the PCF device.

In operation 16 that is optionally performed, the new AMF device may performs a policy association establishment during the registration procedure. Operation 16 may be omitted for the emergency registration.

If the new AMF device contacts with the PCF device identified based on the (V-)PCF ID received during inter-AMF mobility in operation 5, the new AMF device may include the PCF-ID in an Npcf_AMPolicyControl Get operation. This indication may not be included by the AMF device during the initial registration procedure.

If the AMF device notifies mobility restrictions (e.g., UE location) to the PCF device for adjustment, or if the PCF device updates the mobility restrictions due to some conditions (e.g., application in use, time and date), the PCF device may provide the updated mobility restrictions to the AMF device.

In operation 17, the PCF device may invoke the Namf_EventExposure_Subscribe service operation for UE event subscription.

In operation 18 that is conditionally performed, from the AMF device may send Nsmf_PDUSession_UpdateSMContext to the SMF device.

For the emergency registered UE, operation 18 may be applied when the registration type is mobility registration update.

The AMF device may invoke Nsmf_PDUSession_UpdateSMContext in the following scenario(s):

If the “PDU session(s) to be re-activated” is included in the registration request in operation 1, the AMF device may send an Nsmf_PDUSession_UpdateSMContext request to the SMF device(s) associated with the PDU session(s) to activate user plane connections of the PDU session(s). The UE triggered service request executed onwards from operation 5 may be executed to complete the user plane connection activation without sending an MM NAS service accept from the AMF device to (R)AN.

The SMF device may determine to trigger (e.g., intermediate UPF insertion) removal or change of PSA. In the case that insertion, removal, or relocation of the intermediate UPF device is performed for PDU session(s) not included in the “PDU session(s) to be re-activated,” the procedure may be performed without N11 and N2 interactions to update the N3 user plane between (R)AN and the 5GC.

The AMF device may invoke an Nsmf_PDUSession_ReleaseSMContext service operation towards the SMF device in the following scenario:

If any PDU session status indicates that it is released at the UE, the AMF device may invoke an Nsmf_PDUSession_ReleaseSMContext service operation towards the SMF device to release network resources related to the PDU session.

If the registration type indicated by the UE is periodic registration update, operation 20 may be omitted.

If the serving AMF device is changed, the new AMF device may wait until operation 17 is terminated with respect to all the SMF devices associated with the UE. Otherwise, operations 18 to 22 may continue in parallel to this operation.

The mobility related event notifications towards the NF consumers may be triggered at the end of this procedure.

In operation 19, the new AMF device may send an N2 AMF mobility request to N3IWF. If the AMF device is changed, the new AMF device may create an NGAP UE association towards the N3IWF to which the UE is connected.

In operation 20, the N3IWF may send an N2 AMF mobility response to the new AMF device.

In operation 21, the new AMF device may send, to the UE, a registration accept (5G-GUTI, registration area, mobility restrictions, PDU session status, allowed NSSAI, (mapping of allowed NSSAI), periodic registration update timer, LADN information and accepted MICO mode, IMS voice over PS session supported indication, emergency service support indicator).

The AMF device may send a registration accept message to the UE indicating that the registration request is accepted. If the AMF device allocates a new 5G-GUTI, the 5G-GUTI may be included. If the AMF device allocates a new registration area, the AMF device may send the registration area to the UE using the registration accept message. If no registration area is included in the registration accept message, the UE may consider the old registration area as valid. Mobility restrictions may be included if mobility restrictions apply for the UE and the registration type is not emergency registration. The AMF device may indicate the established PDU sessions to the UE in the PDU session status. The UE may locally remove any internal resources related to PDU sessions that are not marked as established in the received PDU session status. When the UE is connected to the two AMF devices belonging to different PLMNs over the 3GPP access and the non-3GPP access, the UE may locally remove any internal resources related to the PDU session of the current PLMN not marked as established in the received PDU session status. If the PDU session status information is included in the registration request, the AMF device may indicate the PDU session status to the UE. The mapping of allowed NSSAI may be mapping of each piece of S-NSSAI of the allowed NSSAI to the S-NSSAI of the configured NSSAI for the HPLMN. The AMF device may include LADN information for LADNs in the registration accept message. The LADN information for the LADNs may be available within the registration area determined by the AMF device for the UE. If the UE included MICO mode is in the request, the AMF device may respond regarding whether the MICO mode needs to be used. The AMF device may set the IMS voice over PS session supported indication. To set the IMS voice over PS session supported indication, the AMF device may need to perform the UE/RAN radio information and compatibility request procedure to verify the compatibility of the UE and RAN radio capabilities related to IMS voice over PS. If the AMF device does not receive a voice support match indicator from the NG-RAN on time, the AMF device may set the IMS voice over PS session supported indication and may update the same at a later stage based on implementation. The emergency service support indicator may inform the UE that emergency services are supported. For example, the UE may be allowed to request a PDU session for emergency services.

In operation 21, a handover restriction list and UE-AMBR may be provided from the AMF device to the NG-RAN.

For the emergency registered UE, no AS security context information may be included in an N2 control message and no NAS level security may be present when the UE is not authenticated.

In operation 22 that is conditionally performed, the UE may send a registration complete message to the new AMF device.

The UE may send the registration complete message to the AMF device in response to assignment of the new 5G-GUTI. When the “PDU session(s) to be re-activated” is not included in the registration request, the AMF device may release the signaling connection with the UE. When the follow-on request is included in the registration request, the AMF device may not release the signaling connection after the completion of the registration procedure. If the AMF device is aware that some signaling is pending in the AMF device or between the UE and the 5GC, the AMF device may not release the signaling connection immediately after the completion of the registration procedure.

<Service Request Procedure: UE Triggered Service Request>

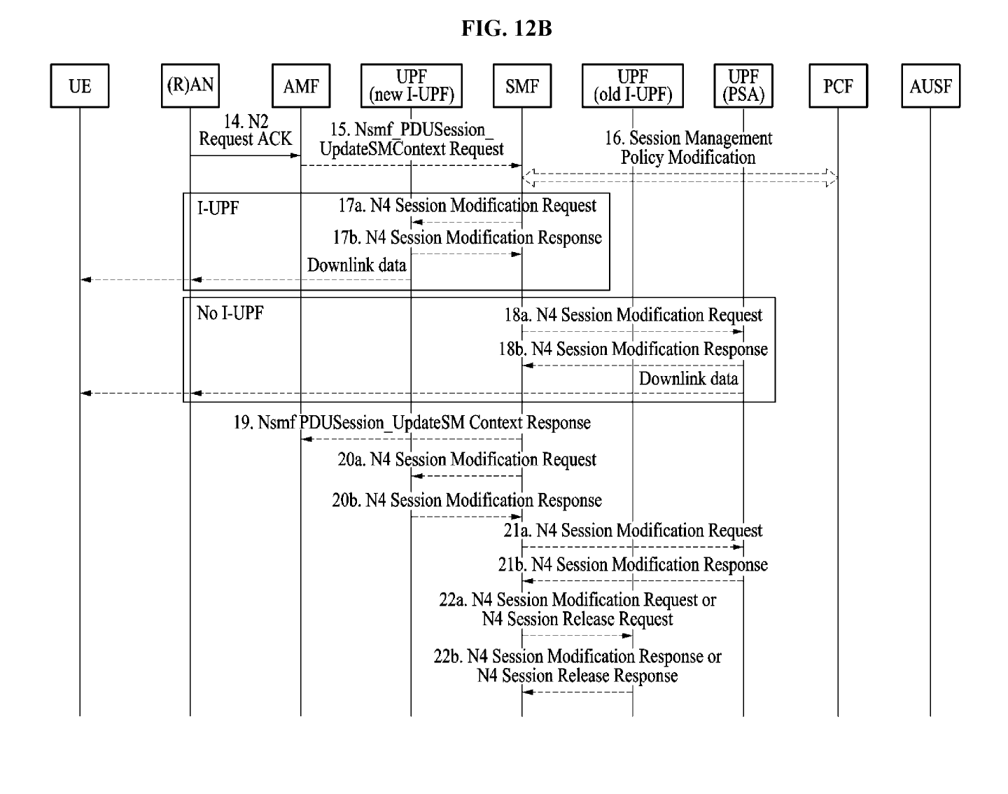

FIGS. 12A and 12B illustrate an example of a UE triggered service request procedure according to an example embodiment.

The UE in a CM-IDLE state initiates the service request procedure to send an uplink signaling message and user data as a response to a network paging request. After receiving a service request message, the AMF device may perform authentication. After establishment of a signaling connection to the AMF device, the UE or the network may send a signaling message, for example, PDU session establishment from the UE to the SMF device, through the AMF device.

The service request procedure is used by the UE in a CM-CONNECTED state to request activation of user plane connection for PDU sessions and to respond to a NAS notification message from the AMF device.

For any service request, the AMF device may respond with a service accept message to synchronize a PDU session status between the UE and the network, if necessary. The AMF device may respond with a service reject message to the UE, if the service request may not be accepted by the network. The service reject message may include an indication or a cause code requesting the UE to perform a registration update procedure.

For the registration update procedure, the impacted SMF device and the UPF device may be all under control of a PLMN serving the UE. For example, in a home routed roaming case, the SMF device and the UPF device in an HPLMN may not be involved.

In the case of a service request by the user data, the network may take further actions if user plane connection activation is not successful.

The UE triggered service request procedure may be applied to a scenario with or without an intermediate UPF device, and with or without reselecting the intermediate UPF device.

Referring to FIGS. 12A and 12B, in operation 1, the UE may send, to the (R)AN, an AN message (AN parameters, MM NAS service request (list Of PDU sessions to be activated, list of allowed PDU sessions, security parameters, PDU session status)).

The list Of PDU sessions to be activated may be provided from the UE when the UE desires to re-activate the PDU session(s). The list of allowed PDU sessions may be provided from the UE when the service request is a response of a paging or a NAS notification for a PDU session associated with a non-3GPP access, and may identify PDU sessions that may be transferred to a 3GPP access.

In the case of NG-RAN:

i) The AN parameters may include a selected PLMN ID and an establishment cause. The establishment cause may provide a reason for requesting establishment of an RRC connection. ii) The UE may send a NAS service request message towards the AMF device encapsulated in an RRC message to the RAN. The RRC message may be used to carry 5G-GUTI and the NAS message.

If the service request is triggered for user data, the UE may identify, using the list of PDU sessions to be activated, the PDU session(s) for which the UP connections are to be activated in the NAS service request message. If the service request is triggered for signaling only, the UE may not identify the PDU sessions to be activated. If this procedure is triggered for paging response and, at the same time, the UE has user data to be transferred, the UE may identify the PDU session(s) for which the UP connections are to be activated in an MM NAS service request message, by the list of PDU sessions to be activated. Otherwise, the UE may not identify PDU session(s) in the service request message for paging response.

If the service request over the 3GPP access is triggered in response to the paging indicating the non-3GPP access, the NAS service request message may identify a list of PDU sessions associated with the non-3GPP access that may be re-activated over 3GPP in the list of allowed PDU sessions.

The PDU session status indicates PDU sessions available in the UE.

The UE may not trigger a service request procedure for a PDU session corresponding to a LADN when the UE is outside a service area of the LADN. The UE may not identify the PDU session(s) in the list of PDU sessions to be activated, if the service request is triggered for other reasons.

For the UE in a CM-CONNECTED state, only the list Of PDU sessions to be activated and the list of allowed PDU sessions need to be included in an MM NAS service request.

In operation 2, the (R)AN may send an N2 message (N2 parameters, MM NAS service request) to the AMF device. If the AMF device is incapable of handling the service request, the AMF device may reject the service request.

When the NG-RAN is used, the N2 parameters may include the 5G-GUTI, the selected PLMN ID, location information, the RAT type, and the establishment cause.

If the UE is in a CM-IDLE state, the RAN may obtain the 5G-GUTI in an RRC procedure. The RAN may select the AMF device based on the 5G-GUTI. The location information and the RAT type may relate to a cell in which the UE is camping.

Based on a PDU session status, the AMF device may initiate a PDU session release procedure in the network for the PDU sessions of which PDU session ID(s) are indicated by the UE as not available.

In operation 3, if the service request is not sent integrity protected or integrity protection verification failed, the AMF device may initiate a NAS authentication/security procedure.

If the UE in the CM-IDLE state triggers the service request to establish a signaling connection only, the UE and the network may exchange NAS signaling after successful establishment of the signaling connection. Here, operations 4 to 10 and 13 to 20 may be omitted.

In operation 4 that is conditionally performed, the AMF device may send, to the SMF device, an Nsmf_PDUSession_UpdateSMContext request (PDU session ID(s), cause(s), UE location information, access type).

The Nsmf_PDUSession_UpdateSMContext request may be invoked:

i) This procedure is triggered if the UE identifies PDU session(s) to be activated in the NAS service request message. ii) This procedure is triggered by the SMF device, however, the PDU session(s) identified by the UE may correlate to other PDU session ID(s) than the PDU session ID triggering the procedure. Alternatively, iii) this procedure is triggered by the SMF device, however, a current UE location may be outside the “area of validity for N2 information” provided from the SMF device. In this case, the AMF device may not send N2 information provided from the SMF device.

The AMF device may determine the PDU session(s) to be activated and may send an Nsmf_PDUSession_UpdateSMContext request to the SMF device(s) associated with the PDU session(s) with a cause set to indicate “establishment of user plane resources” for the PDU session(s).

If the procedure is triggered in response to paging indicating the non-3GPP access, and the PDU session for which the UE is paged is absent in the list of allowed PDU sessions provided from the UE, the AMF device may notify the SMF device that the user plane for the PDU session may not be re-activated. For other PDU sessions in the list of allowed PDU sessions, the service request procedure may succeed without re-activating the user plane of any PDU sessions and the AMF may notify the UE.

The AMF device may receive a service request to establish another NAS signaling connection through a NG-RAN while maintaining an old NAS signaling connection for the UE through the NG-RAN. In this case, the AMF device may trigger an AN release procedure towards the old NG-RAN to release the old NAS signaling connection as defined in the following logic:

i) For the PDU sessions indicated in the “PDU sessions to be activated,” the AMF device may request the SMF device to activate the PDU session(s) immediately by performing operation 4. ii) For the PDU sessions indicated in the “list of PDU session ID(s) with active N3 user plane” but not in the “PDU sessions to be activated,” the AMF device may request the SMF device to deactivate the PDU session(s).

In operation 5, if the PDU session ID corresponds to a LADN and the SMF device determines that the UE is outside a service area of the LADN based on a UE location change notification from the AMF device, the SMF device may determine to (based on local policies) perform either of the following:

i) To maintain the PDU session, but reject the activation of user plane connection for the PDU session and to inform the AMF device about the above event: If the procedure is triggered by a network triggered service request, the SMF device may notify the UPF device to discard downlink data for the PDU sessions and/or to not provide further a data notification message. Alternatively, ii) to release the PDU session: The SMF device may release the PDU session and may inform the AMF device that the PDU session is released.

In any of the above two cases, the SMF device may respond to the AMF device in operation 10 with an appropriate reject cause and the user plane activation of PDU session may be stopped.

Otherwise, the SMF device may verify UPF selection criteria based on location information received from the AMF device, and may determine to perform one of the following:

i) Accept activation of UP connection and continue using a current UPF device. ii) Accept the activation of UP connection and select a new intermediate UPF device (or add/remove an intermediate UPF device), if the UE is outside a service area of the UPF device that is previously connected to the AN, while maintaining a UPF device acting as a PDU session anchor. The operations of performing I-UPF addition/change/removal are described as conditional operations in the following of the current procedure. iii) Reject the activation of UP connection of a PDU session of SSC mode 2, and trigger re-establishment of the PDU session after the service request procedure to perform allocation of a new UPF to act as the PDU session anchor. For example, the UE may be outside the service area of the anchor UPF device that is connecting to the RAN.

In operation 6a that is conditionally performed, an N4 session establishment request may be sent from the SMF device to a new UPF device, for example, the intermediate UPF device.

If the SMF device selects the new UPF device to act as the intermediate UPF device for the PDU session, or if the SMF device selects insertion of the intermediate UPF device for the PDU session that does not have the intermediate UPF device, an N4 session establishment request message may be sent to the new UPF device, providing packet detection, data forwarding, enforcement and reporting rules to be installed on the intermediate UPF device. PDU session anchor addressing information (on N9) for this PDU session may be provided to the intermediate UPF device.

If the new UPF device is selected by the SMF device to replace the old (intermediate) UPF device, the SMF device may include the data forwarding indication. The data forwarding indication indicates to the UPF device that a second tunnel endpoint needs to be reserved for buffered DL data from the old I-UPF device.

In operation 6b, an N4 session establishment response may be sent from the new UPF device, for example, the intermediate UPF device, to the SMF device. The new intermediate UPF device may send an N4 session establishment response message to the SMF device. If the UPF device allocates CN tunnel information, the UPF device may provide DL CN tunnel information for the UPF device acting as the PDU session anchor and UL CN tunnel information (i.e., CN N3 tunnel information) to the SMF device. If the data forwarding indication is received, the new (intermediate) UPF device acting as an N3 terminating point may send DL CN tunnel information for the old (intermediate) UPF device to the SMF device. The SMF device may start a timer to be used in operation 20a of releasing a resource in an old intermediate UPF device.

In operation 7a that is conditionally performed, the SMF device may send an N4 session modification request to the UPF (PSA) device.

If the SMF device selects the new intermediate UPF device for the PDU session or removes the I-UPF device, the SMF device may send an N4 session modification request message to the PDU session anchor UPF device, providing the data forwarding indication and DL tunnel information from the new intermediate UPF device.

If the new intermediate UPF device is added for the PDU session, the UPF (PSA) device may start to send DL data to the new I-UPF device as indicated in the DL tunnel information.

If the service request is triggered by the network and the SMF device removes the old I-UPF device but does not replace the old I-UPF device with the new I-UPF device, the SMF device may include the data forwarding indication in the request. The data forwarding indication may indicate to the UPF (PSA) device that a second tunnel endpoint needs to be reserved for buffered DL data from the old I-UPF device. In this case, the UPF (PSA) device may start to buffer the DL data that is simultaneously received from an N6 interface. An N4 session modification response may be sent from the UPF (PSA) device to the SMF device.

In operation 7b, the UPF (PSA) device may send an N4 session modification response message to the SMF device.

If the data forwarding indication is received, the UPF (PSA) device may act as an N3 terminating point and may send CN DL tunnel information for the old (intermediate) UPF device to the SMF device. The SMF device may start a timer to be used in operation 20a of releasing the resource in the old intermediate UPF device.

If the N3 UPF device is the UPF (PSA) device, and if the SMF device finds that the PDU session is activated in response to receiving the Nsmf_PDUSession_UpdateSMContext request in operation 4 with the Cause set to indicate “establishment of user plane resources” for the PDU session(s), the SMF device may delete RAN tunnel information and initiate an N4 session modification procedure to remove tunnel information of the AN in the UPF device.

In operation 8a that is conditionally performed, the SMF device may send an N4 session modification request (new UPF address, new UPF DL tunnel ID) to the old (intermediate) UPF device.

If the service request is triggered by the network and the SMF device removes the old (intermediate) UPF device, the SMF device may send the N4 session modification request message to the old (intermediate) UPF device, providing the DL tunnel information for the buffered DL data. If the SMF device allocates the new I-UPF device, the DL tunnel information may be received from the new (intermediate) UPF device acting as the N3 terminating point. If the SMF device does not allocate the new I-UPF device, the DL tunnel information may be received from the new UPF (PSA) device acting as the N3 terminating point. The SMF device may start a timer to monitor a forwarding tunnel.

If the SMF device finds that the PDU session is activated in response to receiving the Nsmf_PDUSession_UpdateSMContext request in operation 4 with a cause set to indicate “establishment of user plane resources” for the PDU session(s), the SMF device may delete RAN tunnel information and may initiate the N4 session modification procedure to remove tunnel information of the AN in the UPF device.

In operation 8b, the old (intermediate) UPF device may send an N4 session modification response to the SMF device. The old (intermediate) UPF device may send an N4 session modification response message to the SMF device.

In operation 9 that is conditionally performed, the old (intermediate) UPF device may forward buffered downlink data to the new (intermediate) UPF device.

If the I-UPF device is changed and forwarding tunnel is established in the new I-UPF device, the old (intermediate) UPF device may forward the buffered data to the new (intermediate) UPF device acting as the N3 terminating point.

In operation 10 that is conditionally performed, the old UPF (intermediate) may forward the buffered downlink data to the UPF (PSA) device.

If the old I-UPF device is removed, no new I-UPF device is assigned for the PDU session, and the forwarding tunnel is established in the UPF (PSA) device, the old (intermediate) UPF device may forward the buffered data to the UPF (PSA) device acting as the N3 terminating point.

In operation 11 that is performed conditionally, the SMF device may send, to the AMF device, an Nsmf_PDUSession_UpdateSMContext response (N2 SM information (PDU session ID, QFI(s), QoS profile(s), CN N3 tunnel information, S-NSSAI), cause).

For the PDU session for which the SMF device determines to accept activation of UP connection in operation 5, the SMF device may create only N2 SM information and may send the Nsmf_PDUSession_UpdateSMContext response to the AMF device to establish the user plane(s). The N2 SM information may include information that the AMF device may provide to the RAN. If the SMF device determines to perform PSA UPF relocation for the SSC mode 3 PDU session, the SMF device may trigger a relocation of the SSC mode 3 PDU session anchor after accepting the activation of UP of the PDU session.

In the following cases, the SMF device may reject the activation of UP of the PDU session by including a cause in the Nsmf_PDUSession_UpdateSMContext response:

i) if the PDU session corresponds to a LADN and the UE is outside the service area of the LADN; ii) if the AMF device notifies the SMF device that the UE is reachable only for a regulatory prioritized service, and the PDU session to be activated is not for the regulatory prioritized service; or iii) if the SMF device determines to change the PSA UPF device for the requested PDU session as described in operation 5. In this case, after sending the Nsmf_PDUSession_UpdateSMContext response, the SMF device may trigger another procedure to instruct the UE to re-establish the PDU session as described in operation 5 for SSC mode 2.

In operation 12, the AMF device may send, to the (R)AN, an N2 request (N2 SM information received from the SMF device, security context, AMF signaling connection ID, handover restriction list, subscribed UE-AMBR, MM NAS service accept, list of recommended cells/TAs/NG-RAN node identifiers).

For the UE in a CM-CONNECTED state, if the service request procedure is triggered by the UE, only N2 SM information received from the SMF device and MM NAS service accept may be included in the N2 request. If the service request procedure is triggered by the network as described, only N2 SM information received from the SMF device may be included in the N2 request.

For the UE in a CM-IDLE state, the RAN may store the security context, the AMF signaling connection ID, QoS information for QoS flows of PDU sessions that are activated and N3 tunnel IDs in the UE RAN context.

The MM NAS service accept may include a PDU session status in the AMF device. If the activation of UP of the PDU session is rejected by the SMF device, the MM NAS service accept may include the PDU session ID and a cause why the user plane resources are not activated (e.g., LADN not available). Any local PDU session release during the session request procedure may be indicated to the UE using the session status.

If the plurality of PDU sessions are involved with the plurality of SMF devices, the AMF device may not need to wait for responses from all SMF devices in operation 3 before sending N2 SM information to the UE. However, the AMF device may wait for all responses from the SMF devices before sending an MM NAS service accept message to the UE.

The AMF device may include at least one piece of N2 SM information from the SMF device if this operation is triggered for the PDU session user plane activation. The AMF device may send additional N2 SM information from the SMF device in a separate N2 message (e.g., N2 tunnel setup request). Alternatively, if the plurality of SMF devices are involved, the AMF device may send a single N2 request message to the (R)AN after all the Nsmf_PDUSession_UpdateSMContext response service operations from all the SMF devices associated with the UE are received. In this case, the N2 request message may include N2 SM information received in each of the Nsmf_PDUSession_UpdateSMContext response and PDU session ID to enable the AMF device to associate responses with relevant SMF devices.

If the NG-RAN node provides a list of recommended cells/TAs/NG-RAN node identifiers during the AN release procedure, the AMF device may include the provided list in the N2 request. The RAN may use this information to allocate a RAN notification area when the RAN determines to enable an RRC inactive state for the UE.

In operation 13, the (R)AN may perform the following with respect to the UE. The RAN may perform an RRC connection reconfiguration with the UE based on QoS information for all the QoS flows of PDU sessions of which UP connections are activated and data radio bearers. For the UE in the CM-IDLE state, the user plane security may be established in operation 13.

If the N2 request includes an MM NAS service accept message, the RAN may forward the MM NAS service accept to the UE. The UE may locally delete context of PDU sessions that are not available in the 5GC. Receiving of the service accept message may not indicate a successful activation of user plane radio resources.

Once the user plane radio resources are set up, uplink data from the UE may be forwarded to the RAN. The NG-RAN may send the uplink data to the UPF address and tunnel ID provided in operation 4.

In operation 14 that is conditionally performed, the (R)AN may send, to the AMF device, an N2 request acknowledgement (ACK) (N2 SM information (AN tunnel information, a list of accepted QoS flows for the PDU sessions of which UP connections are activated, a list of rejected QoS flows for the PDU sessions of which UP connections are activated)).

The message may include N2 SM information, e.g., AN tunnel information. The RAN may respond N2 SM information with a separate N2 message (e.g., N2 tunnel setup response) if the AMF device sends the separate N2 message in operation 11.

If a plurality of pieces of N2 SM information are included in the N2 request message in operation 11, the N2 request ACK may include the plurality of pieces of N2 SM information and information to enable the AMF device to associate the response to a relevant SMF device.

In operation 15 that is conditionally performed, the AMF device may send, to the SMF device, an Nsmf_PDUSession_UpdateSMContext request (N2 SM information, RAT type) per PDU session to the SMF device.

If the AMF device receives at least one piece of N2 SM information in operation 14, the AMF device may forward the N2 SM information to the relevant SMF device. If a UE time zone changes compared to a last reported UE time zone, the AMF device may include a UE time zone IE in this message.

In operation 16 that is optionally performed, the SMF device may perform the following with respect to the PCF device. For example, if dynamic PCC is deployed, the SMF device may initiate a notification about new location information with respect to the PCF device (if subscribed) by performing a session management policy modification procedure. The PCF device may provide updated policies.

In operation 17a that is conditionally performed, the SMF device may send, to the new intermediate UPF device, an N4 session modification request (AN tunnel info and a list of accepted QFI(s)).

If the SMF device selects the new UPF device to act as the intermediate UPF device for the PDU session in operation 5, the SMF device may initiate the N4 session modification procedure with respect to the new I-UPF and provide AN tunnel information. Downlink data from the new I-UPF device may be forwarded to the RAN and the UE.

In operation 17b that is conditionally performed, the UPF device may send an N4 session modification response to the SMF device.

In operation 18a that is conditionally performed, the SMF device may send the N4 session modification request (AN tunnel information, list of rejected QoS flows) to the UPF (PSA) device.

If a user plane is to be set up or modified and no I-UPF device is present after the modification, the SMF device may initiate the N4 session modification procedure with respect to UPF (PSA) and may provide AN tunnel information. The downlink data from the UPF (PSA) device may be forwarded to the RAN and the UE.

For QoS flows in the list of rejected QoS flows, the SMF device may instruct the UPF device to remove rules (e.g., packet detection rules etc.) that are associated with the QoS flows.

In operation 18b that is conditionally performed, the UPF device may send an N4 session modification response to the SMF device. In operation 19 that is conditionally performed, the SMF device may send a Nsmf_PDUSession_UpdateSMContext response to the AMF device.

In operation 20a that is conditionally performed, the SMF device may send the N4 session modification request to the AMF device. If forwarding tunnel is established with respect to the new I-UPF device and if the timer SMF set for the forwarding tunnel in operation 8a expires, the SMF device may send the N4 session modification request to the new (intermediate) UPF device acting as the N3 terminating point to release the forwarding tunnel.

In operation 20b that is conditionally performed, the new (intermediate) UPF device may send an N4 session modification response to the SMF device. The new (intermediate) UPF acting as the N3 terminating point may send the N4 session modification response to the SMF device.

In operation 21a that is conditionally performed, the SMF device may send the N4 session modification request to the UPF (PSA) device.

If forwarding tunnel is established to the UPF (PSA) device and if the timer SMF set for the forwarding tunnel in operation 7a expires, the SMF device may send the N4 session modification request to the UPF (PSA) device acting as the N3 terminating point to release the forwarding tunnel.

In operation 21b that is conditionally performed, the UPF (PSA) device may send the N4 session modification response to the SMF device. The UPF (PSA) device acting as the N3 terminating point may send the N4 session modification response to the SMF device.

In operation 22a that is conditionally performed, the SMF device may send the N4 session modification request or N4 session release request to the old UPF device.

If the SMF device determines to continue using the old UPF in operation 5, the SMF device may send the N4 session modification request, providing AN tunnel information.

If the SMF determines to select a new UPF device to act as the intermediate UPF device in operation 5, and the old UPF device is not PSA UPF device, the SMF device may initiate resource release, after the timer in operation 6b expires, by sending the N4 session release request (release cause) to the old intermediate UPF device.

In operation 22b, the old intermediate UPF device may send the N4 session modification response or the N4 session release response to the SMF device.

The old UPF device may make acknowledgement with the N4 session modification response or N4 session release response message to verify modification or release of resources.

Once the procedure is completed, the AMF device may invoke the Namf_EventExposure_Notify service operation to notify the mobility related events.

In response to receiving Namf EventExposure_Notify with an indication that the UE is reachable, if the SMF device has pending DL data, the SMF device may invoke the Namf_Communication_N1N2MessageTransfer service operation to the AMF device to establish the user plane(s) for the PDU sessions. Otherwise, the SMF device may resume sending DL data notifications to the AMF device in case of DL data.

According to an example embodiment, if the UE in an IDLE state moves to a new registration area, the UE may connect to a network temporarily for registration to a new network in response to a change in a registration area. Here, active traffic may be absent. During registration to the new network, the AMF device and the SMF device may manage a location of the UE and the SMF device may determine control of a UPF device, such as I-UPF insertion, removal, and relocation. Based on the determination, an operation, such as I-UPF insertion, removal, and relocation may be performed in a session idle state. That is, during registration to the new network in the session idle state, the UPF device may be controlled and thus, potential interruption may be reduced when providing an actual service.

According to an example embodiment, in the case of performing I-UPF control, such as I-UPF insertion, removal, and relocation, in a session idle state, control of the UPF device may be performed and interface between a base station and the UPF device may not be updated. Accordingly, signaling load between a RAN and a core network may be reduced by not updating in the session idle state.

According to an example embodiment, relocation of a PDU session anchor (PSA) that is a UPF device serving as an anchor gateway of a corresponding PDU session based on a session may be performed to not fix a 5G network and manage a flexible data path. Also, to support a network in which the base station and the PSA are not directly connected, at least one intermediate UPF device may be inserted between the base station and the PSA.

<Change of SSC Mode 2 PDU Session Anchor with Different PDU Sessions>

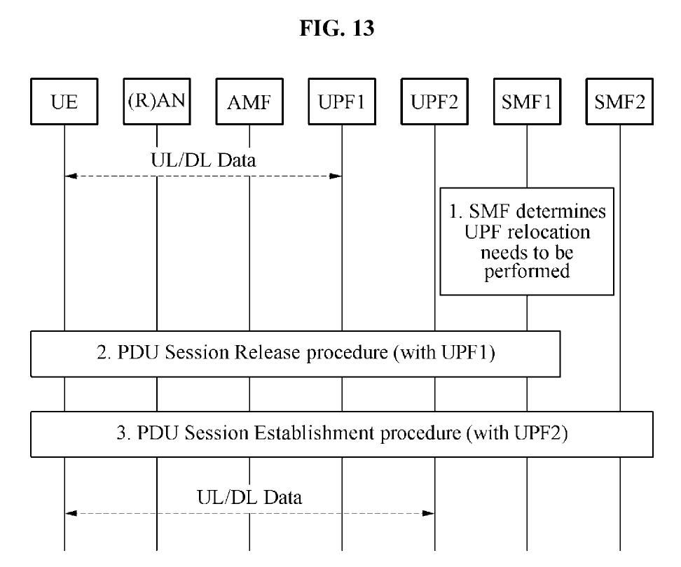

FIG. 13 illustrates an example of a change procedure of SSC mode 2 PSA for a PDU session according to an example embodiment.

FIG. 13 illustrates an example of a procedure that is triggered by an SMF device to change a PDU session anchor serving a PDU session of SSC mode 2 for a UE when neither multi-homing nor UL CL applies to the PDU session. The procedure may release the existing PDU session associated with an old PDU session anchor (UPF1 of FIG. 13) and immediately establish a new PDU session with a new PDU session anchor (UPF2).

Referring to FIG. 13, in operation 1, the SMF device may determine that a serving UPF device needs to be changed due to events that may benefit from such change.

In operation 2, the PDU session release procedure with the old PDU session anchor may be initiated. The SMF device may send N1 SM information to the UE through an AMF device by invoking Namf_Communication_N1N2MessageTransfer. A PDU session release command message in the N1 SM information may contain a PDU session ID and a cause indicating that a PDU session re-establishment in the same DN is required.

In operation 3, in response to receiving the PDU session release command with the cause indicating that the PDU session re-establishment in the same DN is required, the UE may create a new PDU session ID and may initiate a PDU session establishment procedure. The AMF device may select an SMF device and the SMF device may select a new UPF (i.e., UPF2) device for the re-established PDU session of SSC mode 2.

<Change of SSC Mode 3 PDU Session Anchor with Plurality of PDU Sessions>

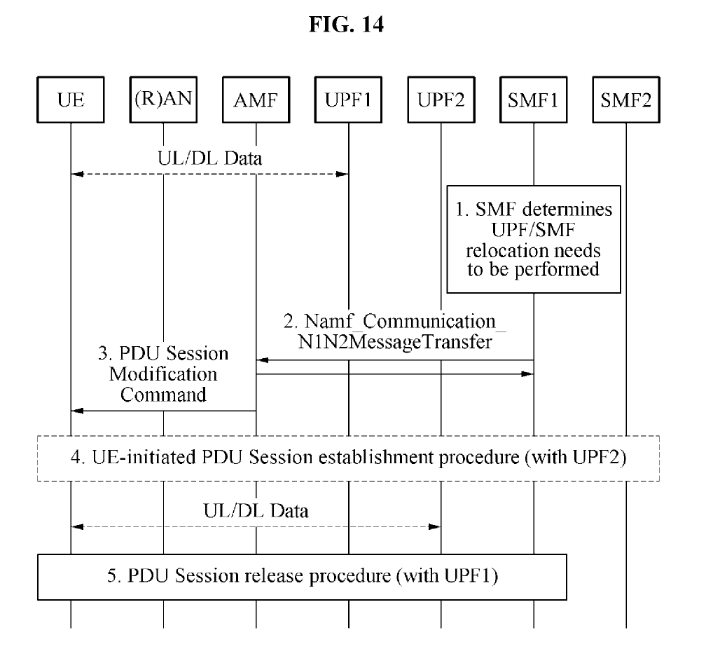

FIG. 14 illustrates an example of a change procedure of session and service continuity (SSC) mode 3 PDU session anchor with the plurality of PDU sessions according to an example embodiment. FIG. 14 illustrates an example of a procedure that is triggered by an SMF device to change a PDU session anchor serving a PDU session of SSC mode 3 for a UE. This procedure may release an existing PDU session associated with an old PDU session anchor (UPF1 of FIG. 14) after establishing a new PDU session in the same DN with a new PDU session anchor (UPF2), which is controlled by the same SMF device. The SMF device may determine that a new SMF device needs to be reallocated.

Referring to FIG. 14, in operation 1, the SMF device may determine that the serving UPF device or the SMF device needs to be changed.

In operation 2, the SMF device may invoke Namf_Communication_N1N2MessageTransfer (PDU session ID, SMF reallocation requested indication, N1 SM container (PDU session modification command (cause, PDU session release timer)). Here, the PDU session ID indicates the existing PDU session to be relocated and the cause indicates that a PDU session re-establishment in the same DN is required.

The SMF reallocation requested indication indicates whether the SMF device is requested to be reallocated. A release timer value indicates an amount of time during which the network is willing to maintain the PDU session.

In operation 3, the AMF device may forward a NAS message to the UE.

In operation 4, if the UE receives the PDU session modification command, the UE may determine to initiate a PDU session establishment procedure.

In an SSC mode, the UE may create a new PDU session ID and initiate a PDU session establishment request using the new PDU session ID. The new PDU session ID may be included as a PDU session ID in a NAS request message. The old PDU session ID indicates that the existing PDU session to be released may also be provided to the AMF device in the NAS request message.

If SMF device reallocation is requested in operation 2, the AMF device may select a different SMF device. Otherwise, the AMF device may send an N11 message to the same SMF device serving the old PDU session ID.

In operation 3, the AMF device may include both the PDU session ID and the old PDU session ID in an Nsmf_PDUSession_CreateSMContext request. The SMF device may detect that the PDU session establishment request is related to the trigger in operation 2 based on the presence of the old PDU session ID in the Nsmf_PDUSession_CreateSMContext request. The SMF device may store the new PDU session ID and may select a new PDU session anchor (i.e., UPF2) for the new PDU Session.

In operation 5, the old PDU session may be released by the UE before the timer provided in operation 1 expires (e.g., once the UE consolidates all traffic on PDU#2 or if the session is no more needed) or by the SMF device upon expiry of this timer.

<Generation Registration>

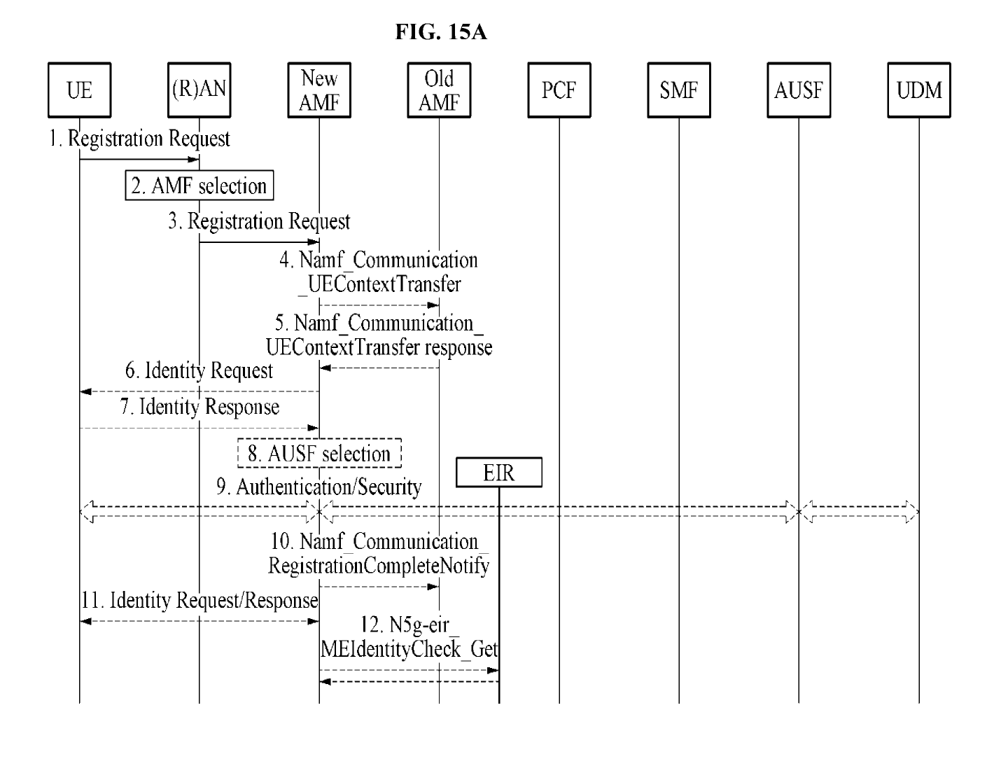

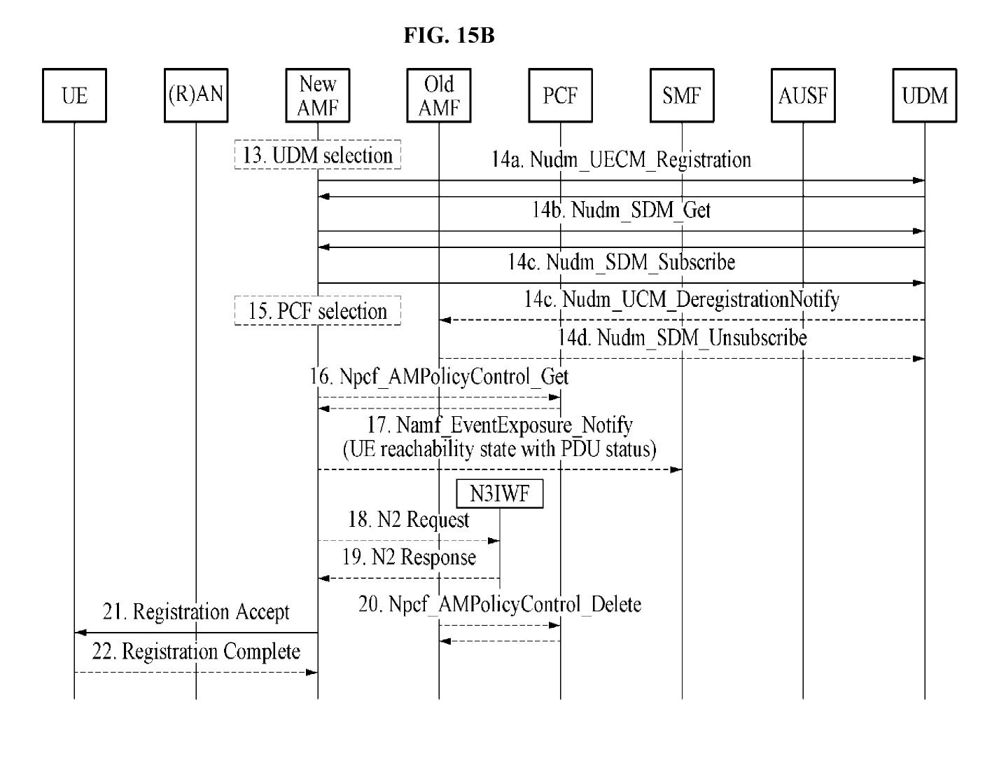

FIGS. 15A and 15B illustrate an example of a UE registration procedure in a communication system according to an example embodiment.

Referring to FIG. 15A, in operation 1, the UE may send, to the (R)AN, an AN message (AN parameters, RM-NAS registration request (registration type, SUCI, SUPI or 5G-GUTI, last visited TAI (if available), security parameters, requested NSSAI, mapping of requested NSSAI, UE 5GC capability, a PDU session status, PDU session(s) to be re-activated, follow-on request, and MICO mode preference) may be sent.

In the case of NG-RAN, the AN parameters may include, for example, the SUCI, the SUPI or the 5G-GUTI, a selected PLMN ID, and the requested NSSAI. The AN parameters may include an establishment cause. The establishment cause may provide a reason for requesting establishment of an RRC connection.

The registration type may indicate whether the UE desires to perform an initial registration (i.e., the UE is in an RM-DEREGISTERED state), a mobility registration update (i.e., the UE is in an RM-REGISTERED state and initiates a registration procedure due to mobility), a periodic registration update (i.e., the UE is in the RM-REGISTERED state and initiates the registration procedure due to expiry of a periodic registration update timer) or an emergency registration (i.e., the UE is in a limited service state). The UE may perform the initial registration (i.e., the UE is in the RM-DEREGISTERED state) to a PLMN for which the UE does not have the 5G-GUTI. The UE may include the SUCI or the SUPI of the UE in the registration request. For the emergency registration, the SUPI may be included if the UE does not have the SUPI and a valid 5G-GUTI SUPI. The PEI may be included when the UE does not have the SUPI and the valid 5G-GUTI SUPI. In other cases, the 5G-GUTI may be included and may indicate a last serving AMF device. If the UE is already registered over the non-3GPP access in a PLMN different from the new PLMN (i.e., not the registered PLMN or an equivalent PLMN of the registered PLMN) of the 3GPP access, the UE may not provide, over the 3GPP access, the 5G-GUTI allocated by the AMF device during the registration procedure over the non-3GPP access. Also, if the UE is already registered over the 3GPP access in the PLMN (i.e., the registered PLMN), different from the new PLMN (i.e., not the registered PLMN or the equivalent PLMN of the registered PLMN) of the non-3GPP access, the UE may not provide, over the non-3GPP access, the 5G-GUTI allocated by the AMF device during the registration procedure over the 3GPP access. The UE may provide a usage setting of the UE based on the configuration of the UE.

If available, the last visited TAI may be included to help the AMF procedure registration area for the UE.

The security parameters may be used for authentication and integrity protection. The requested NSSAI represents network slice selection assistance information. The PDU session status indicates previously established PDU sessions in the UE. PDU session(s) to be re-activated may be included to indicate the PDU session(s) for which the UE intends to activate UP connections. A PDU session corresponding to a LADN may not be included in the PDU session(s) to be re-activated corresponding to the LADN when the UE is outside an area in which the LADN is available. The follow-on request may be included when the UE has pending uplink signaling and does not include PDU session(s) to be re-activated, or when the registration type indicates that the UE desires to perform the emergency registration. HO attach indication may be added.

In operation 2, if the SUPI is included or if the 5G-GUTI does not indicate the valid AMF device, the (R)AN may select the AMF device based on the (R)AT and requested NSSAI.

The (R)AN may select the AMF device. If the UE is in a CM-CONNECTED state, the (R)AN may forward a registration request message to the AMF device based on an N2 connection of the UE. If the (R)AN is incapable of selecting an appropriate AMF device, the (R)AN may forward, to the AMF device, a registration request that is configured in the (R)AN to perform AMF device selection.

In operation 3, the (R)AN may send, to a new AMF device, an N2 message (N2 parameters, RM-NAS registration request (registration type, SUPI or 5G-GUTI, last visited TAI (if available), security parameters, requested NSSAI, mapping of requested NSSAI, UE 5GC capability, PDU session status, PDU session(s) to be re-activated, follow-on request, and MICO mode preference)).

When the NG-RAN is used, the N2 parameters may include a selected PLMN ID, location information, a cell identity and a RAT type related to a cell in which the UE is camping. When the NG-RAN is used, the N2 parameters may also include an establishment cause. If the registration type indicated by the UE is periodic registration update, operations 4 to 17 may be omitted.

In operation 4 that is conditionally performed, the new AMF device may send Namf_Communication_UEContextTransfer (complete registration request) to an old AMF device.

If the 5G-GUTI of the UE is included in the registration request and a serving AMF device is changed since a last registration procedure, the new AMF device may invoke an Namf_Communication_UEContextTransfer service operation on the old AMF device, including a complete registration request IE, which may be integrity protected, to request the SUPI and MM context of the UE. The old AMF device may use the integrity protected complete registration request IE to verify whether a context transfer service operation invocation corresponding to the UE is requested.

The old AMF device may transfer event subscription information by each NF consumer, for the UE, to the new AMF device. Once the UE is successfully registered with the new AMF device, the NF consumers do not need to subscribe for an event once again with the new AMF device.

If the new AMF device has already received UE contexts from the old AMF device during a handover procedure, operations 4,5 and 10 may be omitted.

For the emergency registration, if the UE identifies the UE itself with a 5G-GUTI that is not known to the AMF device, operations 4 and 5 may be omitted. The AMF device may immediately request the UE for the SUPI. If the UE identifies the UE itself with PEI, the SUPI request may be omitted. Allowing the emergency registration without a user identity may depend on local regulations.

In operation 5 that is conditionally performed, the old AMF device may send a response to Namf_Communication_UEContextTransfer (SUPI, MM context, SMF information, PCF ID) to the new AMF device.

The old AMF device may respond to the new AMF device for the Namf_Communication_UEContextTransfer invocation by including the SUPI and the MM context of the UE.

If the old AMF device holds information about established PDU sessions, the old AMF device may include SMF information including S-NSSAI(s), SMF identities and PDU session ID. If the old AMF device holds information about active NGAP UE-TNLA bindings to N3IWF, the old AMF device may include information about the NGAP UE-TNLA bindings.

In operation 6 that is conditionally performed, an identity request may be sent from the new AMF device to the UE device. If the SUPI is not provided from the UE or not retrieved from the old AMF device, an identity request procedure may be initiated in such a manner that the AMF device sends an identity request message to the UE requesting the SUCI.

In operation 7 that is conditionally performed, an identity response may be sent from the UE to the new AMF device. The UE may respond with an identity response message including the SUPI.

In operation 8, the AMF device may determine to initiate UE authentication by invoking an AUSF. In this case, the AMF device may select the AUSF based on the SUPI or the SUCI.

If the AMF device is configured to support the emergency registration for unauthenticated SUPIs and the UE indicated registration type emergency registration, the AMF device may skip the authentication and security setup. Alternatively, the AMF device may accept that the authentication may fail, and may continue the registration procedure.

In operation 9, the AUSF device may execute authentication of the UE.

The authentication may be performed as described by the Nudm_UEAuthenticate_Get operation. The AUSF device may discover a UDM.

If network slicing is used, the AMF device may determine whether the registration request in which the initial AMF device refers to the AMF device needs to be rerouted.

Also, in operation 9, the AMF device may initiate NAS security functions.

In operation 10 that is conditionally performed, the new AMF device may send Namf_Communication_RegistrationCompleteNotify to the old AMF device.

If the AMF device is changed, the new AMF device may notify the old AMF that the registration of the UE in the new AMF device is completed by invoking an Namf_Communication_RegistrationCompleteNotify service operation.

If the authentication/security procedure fails, the registration may be rejected, and the new AMF device may invoke the Namf_Communication_RegistrationCompleteNotify service operation with a reject indication reason code towards the old AMF device. The old AMF device may continue as if the UE context transfer service operation is not received.

If at least one of the S-NSSAI used in the old registration area may not be served in a target registration area, the new AMF device may determine which PDU session may not be supported in the new registration area. The new AMF device may invoke the Namf_Communication_RegistrationCompleteNotify service operation including the rejected PDU session ID and a reject cause (e.g., the S-NSSAI becomes no longer available) towards the old AMF device. In this case, the new AMF device may modify the PDU session status correspondingly. The old AMF device may inform corresponding SMF(s) to locally release the SM context of the UE by invoking the Nsmf_PDUSession_ReleaseSMContext service operation.

In operation 11 that is conditionally performed, an identity request/response (PEI) may be sent from the new AMF device to the UE.

If the PEI is not provided from the UE or not retrieved from the old AMF device, the identity request procedure may be initiated by the AMF device sending an identity request message to the UE to retrieve the PEI. The PEI may be encrypted and thereby transferred unless the UE performs emergency registration and may not be authenticated.

For the emergency registration, the UE may include the PEI in the registration request. In this case, the PEI retrieval may be omitted.

In operation 12, the new AMF device may initiate a ME identity check by invoking the N5g-eir_EquipmentIdentityCheck_Get service operation. For the emergency registration, if the PEI is blocked, operator policies may be used to determine whether to continue or stop the emergency registration procedure continues.

If operation 14 is to be performed, the new AMF device may select a UDM device based on the SUPT in operation 13. In this case, the AMF device may select a UDM.

In operations 14a and 14b, if the AMF device is changed since the last registration procedure, if the UE provides a SUPT that does not refer to a valid context in the AMF device, or if the UE registers to the same AMF device that is already registered to the non-3GPP access (i.e., the UE is registered over the non-3GPP access and initiates this registration procedure to add the 3GPP access), the new AMF device may register with the UDM device using Nudm_UECM_Registration and may subscribe to be notified when the UDM device deregisters this AMF device.

The AMF device may retrieve mobility subscription data using Nudm_SDM_Get and may subscribe using Nudm_SDM_Subscribe when the mobility subscription data is modified. The GPSI may be provided to the AMF device in the subscription data from the UDM device if the GPSI is available in the UE subscription data.

The new AMF device may provide the UDM device with the access type the new AMF device serves for the UE. Here, the access type may be set to “3GPP access.” The UDM device may store the associated access type together with the serving AMF device in UDR by Nudr_UDM_Update.

The new AMF device may create an MM context for the UE after acquiring the mobility subscription data from the UDM device. For the emergency registration in which the UE is not successfully authenticated, the AMF device may not register with the UDM device. For the emergency registration, the AMF device may not verify access restrictions, regional restrictions or subscription restrictions. For the emergency registration, the AMF device may ignore an unsuccessful registration response from the UDM device and continue with the registration procedure.

In operation 14c, when the UDM device stores the associated access type together with the serving AMF device as indicated in operation 14a, it may cause the UDM device to initiate a Nudm_UECM_DeregistrationNotification to the old AMF device corresponding to the 3GPP access, if one exists. The old AMF device may remove the MM context of the UE. If a serving NF removal reason indicated by the UDM device is initial registration, the old AMF may invoke an Namf_EventExposure_Notify service operation towards all the associated SMF devices of the UE to notify that the UE is deregistered from the old AMF device. The SMF device may release the PDU session(s) in response to receiving the notification.

In operation 14d, the old AMF device may cancel subscription to, that is, unsubscribe from the UDM device for subscription data using Nudm_SDM_unsubscribe.

In operation 15, if the new AMF device receives a PCF ID from the old AMF device in operation 5 and successfully contacts with the PCF device identified based on the PCF ID, the AMF device may select the (V-)PCF identified based on the PCF ID. If the PCF device identified by the PCF ID is unavailable (e.g., no response from the PCF device) or if there is no PCF ID received from the old AMF device in operation 5, the AMF device may select the PCF device.

In operation 16, the new AMF device may send Npcf AMPolicyControl Get (SUPI, GPSI) to the PCF device.

If the AMF device has not yet obtained an access and mobility policy for the UE or if the access and mobility policy in the AMF device is no longer valid, the AMF device may request the PCF device to apply operator policies for the UE from the PCF device through an Npcf_AMPolicyControl_Get service operation. The GPSI may be included if available at the AMF device. In a roaming case, an interaction between H-PCF and V-PCF is required for providing the access and mobility policy. For an emergency registration, this operation may be omitted.

The PCF device may send a response to Npcf_AMPolicyControl_Get (access and mobility policy data) to the new AMF device.

The PCF device may respond to the Npcf_AMPolicyControl_Get service operation and may provide the access and mobility policy data for the UE to the AMF device.

In operation 17 that is conditionally performed, the AMF device may send Nsmf_EventExposure_Notify ( ) or Nsmf_PDUSession_UpdateSMContext to the SMF device.

For the emergency registered UE, operation 18 may be applied when the registration type is mobility registration update.

The AMF device may invoke Namf Nsmf_EventExposure_Notify ( ) or Nsmf_PDUSession_UpdateSMContext in the following scenario(s):

If the AMF device is changed, the new AMF device may notify each SMF device of the new AMF device serving the UE by informing the UE reachability status. If the AMF device is changed, it is assumed that the old AMF device provides available SMF information. If any PDU session status indicates that it is released at the UE, the AMF device may invoke an Nsmf_PDUSession_ReleaseSMContext service operation towards the SMF device to release any network resources related to the PDU Session.

If the “PDU session(s) to be re-activated” is included in the registration request in operation 1, the AMF device may send an Nsmf_PDUSession_UpdateSMContext request to the SMF device(s) associated with the PDU session(s) to activate user plane connections of the PDU session(s). The UE triggered service request executed onwards from operation 5 onwards may be executed to complete the user plane connection activation without sending MM NAS service accept from the AMF device to (R)AN.

If the UE is in a MICO mode, he AMF device notifies the SMF device of the UE being unreachable, and the SMF device does not need to send DL data notifications to the AMF device, the AMF device may inform the SMF device that the UE is reachable.

If the AMF device notifies the SMF device of the UE being reachable only for a regulatory prioritized service and the UE enters into an allowed area, the AMF device may inform the SMF device that the UE is reachable.

If the UE is in a non-allowed area and the PDU session(s) to be re-activated is included in the registration request, the AMF device may inform all the associated SMF device(s) that the UE is reachable only for the regulatory prioritized service.

The AMF device may also notify any NF(s) that subscribes to UE reachability of the change of UE reachability.

If the SMF device subscribes to a UE location change notification through an Namf_EventExposure_Subscribe service operation and if the AMF device detects that the UE is outside the area of interest subscribed by the SMF device serving the UE, the AMF device may invoke an Namf_EventExposure_Notify service operation to inform the SMF device of new location information of the UE.

Whether a notification ACK needs a separate message or is realized in a transport layer may be determined.

The SMF device may determine to trigger, for example, new intermediate UPF insertion, removal, or relocation, or UPF relocation. If the new intermediate UPF insertion, removal, or relocation is performed for the PDU session(s) not included in “PDU session(s) to be re-activated,” the procedure may be performed without N11 and N2 interactions to update an N3 user plane between the (R)AN and the 5GC. If the registration type indicated by the UE is periodic registration update, operation 20 may be omitted.

If the serving AMF device is changed, the new AMF device may need to wait until operation 17 is completed with respect to all the SMF devices associated with the UE. Otherwise, operations 18 to 22 may continue in parallel to this operation.

In operation 18, the new AMF device may send an N2 request to N3IWF. The AMF device may determine to modify the NGAP UE-TNLA-binding towards N3IWF. This is performed when the AMF device is changed and the old AMF device has existing NGAP UE-TNLA-bindings towards a N3IWF for the UE.

In operation 19, the N3IWF may send an N2 response to the new AMF device.

In operation 20 that is conditionally performed, the old AMF device may send Npcf_AMPolicyControl_Delete to the PCF device. If the old AMF device has previously requested UE context to be established in the PCF device, the old AMF device may terminate the UE context in the PCF device by invoking an Npcf_AMPolicyControl_Delete service operation. The PCF device may send a response to Npcf_AMPolicyControl_Delete to the old AMF device.

In operation 21, the new AMF device may send, to the UE, a registration accept (5G-GUTI, registration area, mobility restrictions, PDU session status, allowed NSSAI, (mapping of allowed NSSAI), periodic registration update timer, LADN information and accepted MICO mode, IMS voice over PS session supported indication, emergency service support indicator).

The AMF device may send a registration accept message to the UE indicating that the registration request is accepted. If the AMF device allocates a new 5G-GUTI, 5G-GUTI may be included. If the AMF device allocates a new registration area, the AMF device may send the registration area to the UE using the registration accept message. If no registration area is included in the registration accept message, the UE may consider the old registration area as valid. Mobility restrictions may be included if mobility restrictions apply for the UE and the registration type is not emergency registration. The AMF device may indicate the established PDU sessions to the UE in the PDU session status. The UE may locally remove any internal resources related to PDU sessions that are not marked as established in the received PDU session status. When the UE is connected to the two AMF devices belonging to different PLMNs over the 3GPP access and the non-3GPP access, the UE may locally remove any internal resources related to the PDU session of the current PLMN not marked as established in the received PDU session status. If the PDU session status information is included in the registration request, the AMF device may indicate the PDU session status to the UE. The mapping of allowed NSSAI may be mapping of each piece of S-NSSAI of the allowed NSSAI to the S-NSSAI of the configured NSSAI for the HPLMN. The AMF device may include LADN information for LADNs in the registration accept message. The LADN information for the LADNs may be available within the registration area determined by the AMF device for the UE. If the UE included MICO mode is in the request, the AMF device may respond regarding whether the MICO mode needs to be used. The AMF device may set the IMS Voice over PS session supported indication. To set the IMS voice over PS session supported indication, the AMF device may need to perform the UE/RAN radio information and compatibility request procedure to verify the compatibility of the UE and RAN radio capabilities related to IMS voice over PS. If the AMF device does not receive a voice support match indicator from the NG-RAN on time, the AMF device may set the IMS Voice over PS session supported Indication and update the same at a later stage based on implementation. The emergency service support indicator may inform the UE that emergency services are supported. For example, the UE may be allowed to request a PDU session for emergency services.

In operation 21, a handover restriction list and UE-AMBR may be provided from the AMF device to the NG-RAN.

When the follow-on request is included, the AMF device may not release signaling connection immediately after completion of the registration procedure. For the emergency registered UE, no AS security context information may be included in an N2 control message and no NAS level security may be present when the UE is incapable of being authenticated.

In operation 22 that is conditionally performed, the UE may send a registration complete message to the new AMF device.

The UE may send the registration complete message to the AMF device in response to assignment of the new 5G-GUTI. When the “PDU session(s) to be re-activated” is not included in the registration request, the AMF device may release the signaling connection with the UE. When the follow-on request is included in the registration request, the AMF device may not release the signaling connection after the completion of the registration procedure. For example, if the AMF device determines that an additional signaling procedure may follow on, for example, based on receiving of the Namf_Communication_N1N2MessageTransfer request without the last message indication, the AMF device is not allowed to release the signaling connection immediately after the completion of the registration procedure.

<UE Triggered Service Request in CM-IDLE State>

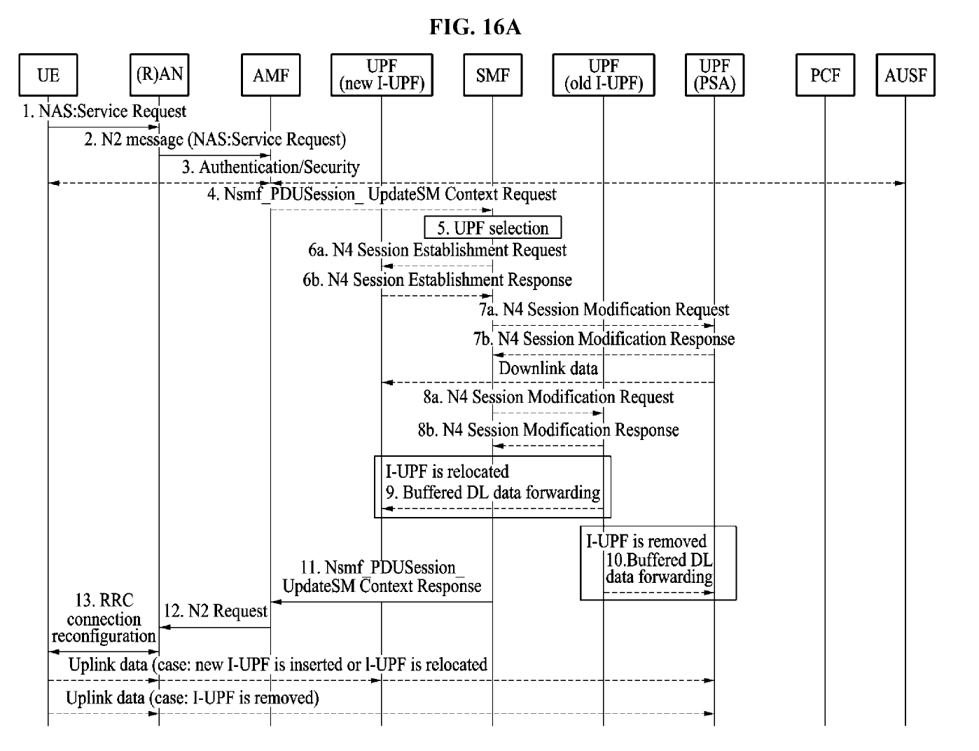

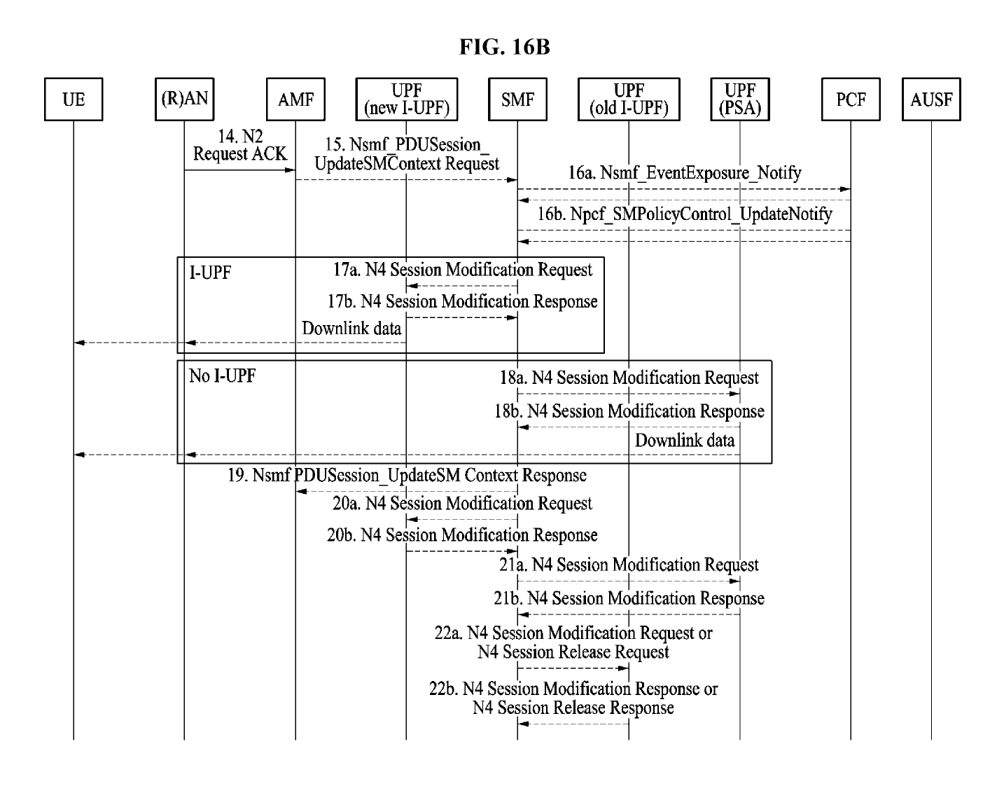

FIGS. 16A and 16B illustrate an example of a UE triggered service request procedure in a CM-IDLE state according to an example embodiment.

The UE in a CM-IDLE state initiates the service request procedure to send an uplink signaling messages and user data as a response to a network paging request. After receiving a service request message, the AMF device may perform authentication. After the establishment of a signaling connection to the AMF device, the UE or the network may send a signaling messages, for example, PDU session establishment from the UE to the SMF device, through the AMF device.

For any service request, the AMF device may respond with a service accept message to synchronize a PDU session status between the UE and the network, if necessary. The AMF device may respond with a service reject message to the UE, if the service request may not be accepted by the network. The service reject message may include an indication or a cause code requesting the UE to perform a registration update procedure.

In the case of a service request by the user data, the network may take further actions if user plane connection activation is not successful. The UE triggered service request procedure may be applied to a scenario with or without an intermediate UPF device, and with or without reselecting the intermediate UPF device.

The UE triggered service request procedure in the CM-IDLE state may be inappropriate for an access network (once the UE is registered in the network) in which the UE is always considered as in a CM-CONNECTED state and in which user plane connection is always considered as active for an established PDU session.

Referring to FIG. 16A, in operation 1, the UE may send, to the (R)AN, an AN message (AN parameters, MM NAS service request (list Of PDU sessions to be activated, list of allowed PDU sessions, security parameters, PDU session status)).

The list Of PDU sessions to be activated may be provided from the UE when the UE desires to re-activate the PDU session(s). The list of allowed PDU sessions may be provided from the UE when the service request is a response of a paging or a NAS Notification for a PDU session associated with a non-3GPP access, and may identify PDU sessions that may be transferred to a 3GPP access.

In the case of NG-RAN:

i) The AN parameters may include a Selected PLMN ID and an establishment cause. The establishment cause may provide a reason for requesting establishment of an RRC connection. ii) The UE may send a NAS service request message towards the AMF device encapsulated in an RRC message to the RAN. The RRC message may be used to carry 5G-GUTI and the NAS message.

If the service request is triggered for user data, the UE may identify, using the list of PDU sessions to be activated, the PDU session(s) for which the UP connections are to be activated in the NAS service request message. If the service request is triggered for signaling only, the UE may not identify the PDU sessions to be activated. If this procedure is triggered for paging response and, at the same time, the UE has user data to be transferred, the UE may identify the PDU session(s) for which the UP connections are to be activated in an MM NAS service request message, by the list of PDU sessions to be activated. Otherwise, the UE may not identify PDU session(s) in the service request message for paging response.

If the service request over the 3GPP access is triggered in response to the paging indicating the non-3GPP access, the NAS service request message may identify a list of PDU sessions associated with the non-3GPP access that may be re-activated over 3GPP in the list of allowed PDU sessions.

The PDU session status indicates PDU sessions available in the UE.

The UE may not trigger a service request procedure for a PDU session corresponding to a LADN when the UE is outside a service area of the LADN. The UE may not identify the PDU session(s) in the list of PDU sessions to be activated, if the service request is triggered for other reasons.

In operation 2, the (R)AN may send an N2 Message (N2 parameters, MM NAS service request) to the AMF device. If the AMF device is incapable of handling the service request, the AMF device may reject the service request.

When the NG-RAN is used, the N2 parameters may include the 5G-GUTI, the selected PLMN ID, location information, the RAT type, and the establishment cause.

The 5G-GUTI may be obtained in an RRC procedure. The RAN may select the AMF device based on the 5G-GUTI. The location information and the RAT type may relate to a cell in which the UE is camping.

Based on a PDU session status, the AMF device may initiate a PDU session release procedure in the network for the PDU sessions of which PDU session ID(s) are indicated by the UE as not available.

In operation 3, if the service request is not sent integrity protected or integrity protection verification failed, the AMF device may initiate a NAS authentication/security procedure. If the UE in the CM-IDLE state triggers the service request to establish a signaling connection only, the UE and the network may exchange NAS signaling after successful establishment of the signaling connection. Here, operations 4 to 10 and 13 to 20 may be omitted.

In operation 4 that is conditionally performed, the AMF device may send, to the SMF device, an Nsmf_PDUSession_UpdateSMContext request (PDU session ID(s), Cause(s), UE location information, access type).

The Nsmf_PDUSession_UpdateSMContext request may be invoked:

i) This procedure is triggered if the UE identifies PDU session(s) to be activated in the NAS service request message. ii) This procedure is triggered by the SMF device, however, the PDU session(s) identified by the UE may correlate to other PDU session ID(s) than the PDU session ID triggering the procedure. Alternatively, iii) this procedure is triggered by the SMF device, however, a current UE location may be outside the “area of validity for the N2 information” provided from the SMF device. In this case, the AMF device may not send N2 information provided from the SMF device.

The AMF device may determine the PDU session(s) to be activated and may send an Nsmf_PDUSession_UpdateSMContext request to the SMF device(s) associated with the PDU session(s) with a cause set to indicate “establishment of user plane resources” for the PDU session(s).

If the procedure is triggered in response to paging indicating the non-3GPP access, and the PDU session for which the UE is paged is absent in the list of allowed PDU sessions provided from the UE, the AMF device may notify the SMF device that the user plane for the PDU session may not be re-activated. For other PDU sessions in the list of allowed PDU sessions, the service request procedure may succeed without re-activating the user plane of any PDU sessions and the AMF may notify the UE.

In operation 5, if the PDU session ID corresponds to a LADN and the SMF device determines that the UE is outside a service area of the LADN based on a UE location change notification from the AMF device, the SMF device may determine to (based on local policies) perform either of the following:

i) To maintain the PDU session, but reject the activation of user plane connection for the PDU session and to inform the AMF device about the above event: If the procedure is triggered by a network triggered service request, the SMF device may notify the UPF device to discard downlink data for the PDU sessions and/or to not provide further a data notification message. Alternatively, ii) to release the PDU session: The SMF device may release the PDU session and may inform the AMF device that the PDU session is released.

In any of the above two cases, the SMF device may respond to the AMF device in operation 10 with an appropriate reject cause and the user plane activation of PDU session may be stopped.

Otherwise, the SMF device may verify UPF selection criteria based on location information received from the AMF device and may determine to perform one of the following:

i) Continue using the current UPF device(s). ii) Select a new intermediate UPF (or add/remove the intermediate UPF) device, if the UE is outside the service area of the UPF device that is previously connected to the AN, while maintaining the UPF device(s) acting as a PDU session anchor. Operations of performing I-UPF device addition/relocation/removal are described as conditional operations in the following of the current procedure.

Here, if the old and/or new I-UPF device implements an UL CL or BP functionality and a PDU session anchor for connectivity to the local access to the data network, the described signaling is intended as the signaling to add, remove or relocate the PDU session anchor, and needs to be complemented by the signaling to add, release or relocate the UL CL or BP.

i) Trigger re-establishment of the PDU session to perform relocation of the UPF device acting as the PDU session anchor. For example, the UE may be outside the service area of the anchor UPF device that is connecting to the RAN.

In operation 6a that is conditionally performed, an N4 session establishment request may be sent from the SMF device to a new UPF device, for example, the intermediate UPF device.

If the SMF device selects the new UPF device to act as the intermediate UPF device for the PDU session, or if the SMF device selects insertion of the intermediate UPF device for the PDU session that does not have the intermediate UPF device, an N4 session establishment request message may be sent to the new UPF device, providing packet detection, data forwarding, enforcement and reporting rules to be installed on the intermediate UPF device. PDU session anchor addressing information (on N9) for this PDU session may be provided to the intermediate UPF device.

If the new UPF device is selected by the SMF device to replace the old (intermediate) UPF device, the SMF device may include the data forwarding indication. The data forwarding indication indicates to the UPF device that a second tunnel endpoint needs to be reserved for buffered DL data from the old I-UPF device.

In operation 6b, an N4 session establishment response may be sent from the new UPF device, for example, the intermediate UPF device, to the SMF device. The new intermediate UPF device may send an N4 session establishment response message to the SMF device. If the UPF device allocates CN tunnel information, the UPF device may provide DL CN tunnel information for the UPF device acting as the PDU session anchor and UL CN tunnel information (i.e., CN N3 tunnel information) to the SMF device. If the data forwarding indication is received, the new (intermediate) UPF device acting as an N3 terminating point may send DL CN tunnel information for the old (intermediate) UPF device to the SMF device. The SMF device may start a timer to be used in operation 20a of releasing a resource in an old intermediate UPF device.

In operation 7a that is conditionally performed, the SMF device may send an N4 session modification request to the UPF (PSA) device.

If the SMF device selects the new intermediate UPF device for the PDU session or removes the I-UPF device, the SMF device may send an N4 session modification request message to the PDU session anchor UPF device, providing the data forwarding indication and DL tunnel information from the new intermediate UPF device.

If the new intermediate UPF device is added for the PDU session, the UPF (PSA) device may start to send DL data to the new I-UPF device as indicated in the DL tunnel information.

If the service request is triggered by the network, and the SMF device removes the old I-UPF device but does not replace the old I-UPF device with the new I-UPF device, the SMF device may include the data forwarding indication in the request. The data forwarding indication may indicate to the UPF (PSA) device that a second tunnel endpoint needs to be reserved for buffered DL data from the old I-UPF device. In this case, the UPF (PSA) device may start to buffer the DL data that is simultaneously received from an N6 interface. An N4 session modification response may be sent from the UPF (PSA) device to the SMF device.

In operation 8a that is conditionally performed, the SMF device may send an N4 session modification request (New UPF address, New UPF DL tunnel ID) to the old (intermediate) UPF device.

If the service request is triggered by the network, and the SMF device removes the old (intermediate) UPF device, the SMF device may send the N4 session modification request message to the old (intermediate) UPF device, providing the DL tunnel information for the buffered DL data. If the SMF device allocates the new I-UPF device, the DL tunnel information may be received from the new (intermediate) UPF device acting as the N3 terminating point. If the SMF device does not allocate the new I-UPF device, the DL tunnel information may be received from the new UPF (PSA) device acting as the N3 terminating point. The SMF device may start a timer to monitor a forwarding tunnel.

In operation 8b, the old (intermediate) UPF device may send an N4 session modification response to the SMF device. The old (intermediate) UPF device may send an N4 session modification response message to the SMF device.

In operation 9 that is conditionally performed, the old (intermediate) UPF device may forward buffered downlink data to the new (intermediate) UPF device.

If the I-UPF device is changed and forwarding tunnel is established in the new I-UPF device, the old (intermediate) UPF device may forwards the buffered data to the new (intermediate) UPF device acting as the N3 terminating point.

In operation 10 that is conditionally performed, the old UPF (intermediate) may forward the buffered downlink data to the UPF (PSA) device.

If the old I-UPF device is removed, no new I-UPF device is assigned for the PDU session, and the forwarding tunnel is established in the UPF (PSA) device, the old (intermediate) UPF device may forward the buffered data to the UPF (PSA) device acting as the N3 terminating point.

In operation 11 that is performed conditionally, the SMF device may send, to the AMF device, an Nsmf_PDUSession_UpdateSMContext response (N2 SM information (PDU session ID, QFI(s), QoS profile(s), CN N3 tunnel information, S-NSSAI), cause).

Also, in response to receiving the Nsmf_PDUSession_UpdateSMContext request in operation 4 with a cause including “establishment of user plane resources,” the SMF device may determine whether UPF reallocation is performed, based on UE location information, a UPF service area and operator policies:

i) For a PDU session that the SMF device determines still to be served by the current UPF device, i.e., the PDU session anchor or the intermediate UPF device in operation 5, the SMF device may create only N2 SM information and may send the Nsmf_PDUSession_UpdateSMContext response to the AMF device to establish the user plane(s). The N2 SM information may include information that is to be provided from the AMF device to the RAN. ii) For a PDU session that the SMF device determines as needing a UPF relocation for a PDU session anchor UPF device is needed in operation 5, the SMF device may reject the activation of UP of the PDU session by sending the Nsmf_PDUSession_UpdateSMContext response by including a proper cause in the message. The SMF device may trigger relocation of the PDU session anchor UPF device(s) according to the SSC mode of the PDU session(s). The UE may initiate a PDU session re-establishment for this/these PDU session(s) after the service request procedure is completed.

In response to receiving the Namf_EventExposure_Notify in operation 4 with an indication that the UE is reachable, if the SMF device has pending DL data, the SMF device may invoke the Namf_Communication_N1N2MessageTransfer service operation to the AMF device to establish the user plane(s) for the PDU sessions. Otherwise, the SMF device may resume sending DL data notifications to the AMF device in case of DL data.

In the following cases, the SMF device may reject the activation of UP of the PDU session by including a cause in the Nsmf_PDUSession_UpdateSMContext response:

i) if the PDU session corresponds to a LADN and the UE is outside the service area of the LADN; ii) if the AMF device notifies the SMF device that the UE is reachable only for a regulatory prioritized service, and the PDU session to be activated is not for the regulatory prioritized service; or iii) if the SMF device determines to performs relocation of the PSA UPF device for the requested PDU session.

In operation 12, the AMF device may send, to the (R)AN, an N2 request (N2 SM information received from the SMF device, security context, AMF signaling connection ID, handover restriction list, subscribed UE-AMBR, MM NAS service accept, list of recommended cells/TAs/NG-RAN node identifiers).

The RAN may store the security context, the AMF signaling Connection ID, QoS information for the QoS flows of the PDU sessions that are activated and N3 tunnel IDs in the UE RAN context.

The MM NAS service accept may include a PDU session status in the AMF device. If the activation of UP of the PDU session is rejected by the SMF device, the MM NAS service accept may include the PDU session ID and a cause why the user plane resources are not activated (e.g., a LADN not available). Any local PDU session release during the session request procedure may be indicated to the UE using the session status.

If the plurality of PDU sessions are involved with the plurality of SMF devices, the AMF device may not need to wait for responses from all SMF devices in operation 3 before sending N2 SM information to the UE. However, the AMF device may wait for all responses from the SMF devices before sending an MM NAS service accept message to the UE.

The AMF device may include at least one piece of N2 SM information from the SMF device if this operation is triggered for the PDU session user plane activation. The AMF device may send additional N2 SM information from the SMF device in a separate N2 message (e.g., N2 tunnel setup request). Alternatively, if the plurality of SMF devices are involved, the AMF device may send a single N2 request message to the (R)AN after all the Nsmf_PDUSession_UpdateSMContext response service operations from all the SMF devices associated with the UE are received. In this case, the N2 request message may include N2 SM information received in each of the Nsmf_PDUSession_UpdateSMContext response and PDU session ID to enable the AMF device to associate responses with relevant SMF devices.

If the NG-RAN node provides a list of recommended cells/TAs/NG-RAN node identifiers during the AN release procedure, the AMF device may include the provided list in the N2 request. The RAN may use this information to allocate a RAN notification area when the RAN determines to enable an RRC inactive state for the UE.

If the AMF device receives an indication, from the SMF during the PDU session establishment procedure that the UE is using a PDU session related to latency sensitive services, for any of the PDU Sessions established for the UE and the AMF receives an indication from the UE that supports the CM-CONNECTED with an RRC inactive state, the AMF device may include “RRC Inactive assistance information” of the UE. Otherwise, the AMF device based on network configuration may include “RRC inactive assistance information” of the UE.

In operation 13, the (R)AN may perform the following with respect to the UE. The RAN may perform an RRC connection reconfiguration with the UE based on QoS information for all the QoS flows of PDU sessions of which UP connections are activated and data radio bearers. For the UE in the CM-IDLE state, the user plane security may be established in operation 13 operation.

If the N2 request includes an MM NAS service accept message, the RAN may forward the MM NAS service accept to the UE. The UE may locally delete context of PDU sessions that are not available in the 5GC. Receiving of the service accept message may not indicate a successful activation of user plane radio resources.

Once the user plane radio resources are set up, uplink data from the UE may be forwarded to the RAN. The NG-RAN may send the uplink data to the UPF address and tunnel ID provided in operation 4.

In operation 14 that is conditionally performed, the (R)AN may send, to the AMF device, an N2 request ACK (N2 SM information (AN tunnel information, a list of accepted QoS flows for the PDU sessions of which UP connections are activated, a list of rejected QoS flows for the PDU sessions of which UP connections are activated)).

The message may include N2 SM information, e.g., AN tunnel information. The RAN may respond N2 SM information with a separate N2 message (e.g., N2 tunnel setup response) if the AMF device sends the separate N2 message in operation 11.

If a plurality of pieces of N2 SM information are included in the N2 request message in operation 11, the N2 request ACK may include the plurality of pieces of N2 SM information and information to enable the AMF device to associate the responses to a relevant SMF device.

In operation 15 that is conditionally performed, the AMF device may send, to the SMF device, an Nsmf_PDUSession_UpdateSMContext request (N2 SM information, RAT type) per PDU session to the SMF device.

If the AMF device receives at least one piece of N2 SM information in operation 14, the AMF device may forward the N2 SM information to the relevant SMF device. If a UE time zone changes compared to a last reported UE time zone, the AMF device may include a UE time zone IE in this message.

In operation 16 that is optionally performed, the SMF device may perform the following with respect to the PCF device. For example, if dynamic PCC is deployed, the SMF device may initiate a notification about new location information with respect to the PCF device (if subscribed) by invoking an Nsmf_EventExposure_Notify service operation. The PCF device may provide updated policies by invoking an Npcf_SMPolicyControl_UpdateNotify operation.

In operation 17a that is conditionally performed, the SMF device may send, to the new intermediate UPF device, an N4 session modification request (AN tunnel info and a list of accepted QFI(s)).

If the SMF device selects the new UPF device to act as the intermediate UPF device for the PDU session in operation 5, the SMF device may initiate the N4 session modification procedure with respect to the new I-UPF and provide AN tunnel information. Downlink data from the new I-UPF device may be forwarded to the RAN and the UE.

In operation 17b that is conditionally performed, the UPF device may send an N4 session modification response to the SMF device.

In operation 18a that is conditionally performed, the SMF device may send the N4 session modification request (AN tunnel information) to the UPF (PSA) device.

If a user plane is to be set up or modified and no I-UPF device is present after the modification, the SMF device may initiate the N4 session modification procedure with respect to UPF (PSA) and may provide AN tunnel information. The downlink data from the UPF (PSA) device may be forwarded to the RAN and the UE.

In operation 18b that is conditionally performed, the UPF device may send an N4 session modification response to the SMF device. In operation 19 that is conditionally performed, the SMF device may send a Nsmf_PDUSession_UpdateSMContext response to the AMF device.

In operation 20a that is conditionally performed, the SMF device may send the N4 session modification request to the AMF device. If forwarding tunnel is established with respect to the new I-UPF device and if the timer SMF set for the forwarding tunnel in operation 8a expires, the SMF device may send the N4 session modification request to the new (intermediate) UPF device acting as the N3 terminating point to release the forwarding tunnel.

In operation 20b that is conditionally performed, the new (intermediate) UPF device may send an N4 session modification response to the SMF device. The new (intermediate) UPF acting as the N3 terminating point may send the N4 session modification response to the SMF device.

In operation 21a that is conditionally performed, the SMF device may send the N4 session modification request to the UPF (PSA) device.

If forwarding tunnel is established to the UPF (PSA) device and if the timer SMF set for the forwarding tunnel in operation 7a expires, the SMF device may send the N4 session modification request to the UPF (PSA) device acting as the N3 terminating point to release the forwarding tunnel.

In operation 21b that is conditionally performed, the UPF (PSA) device may send the N4 session modification response to the SMF device. The UPF (PSA) device acting as the N3 terminating point may send the N4 session modification response to the SMF device.

In operation 22a that is conditionally performed, the SMF device may send the N4 session modification request or the N4 session release request to the old UPF device.

If the SMF device determines to continue using the old UPF in operation 5, the SMF device may send the N4 session modification request, providing AN tunnel information.

If the SMF determines to select a new UPF device to act as the intermediate UPF device in operation 5, and the old UPF device is not PSA UPF device, the SMF device may initiate resource release, after the timer in operation 6b expires, by sending the N4 session release request (release cause) to the old intermediate UPF device.

In operation 22b, the old intermediate UPF device may send the N4 session modification response or the N4 session release response to the SMF device.

The old UPF device may make acknowledgement with the N4 session modification response or N4 session release response message to verify modification or release of resources.

The AMF device may invoke the Namf_EventExposure_Notify service operation to notify mobility related events, after this procedure completes, towards the NFs that subscribe for the events. The following relates to cases in which the AMF device invokes the Namf_EventExposure_Notify towards the SMF device:

i) If the SMF device subscribes for the UE moving into or out of “area of interest” and if a current location of the UE indicates that the UE is either moving into or moving outside of the “Area of interest” subscribed; ii) if the SMF device subscribes for “LADN DNN” and if the UE is moving into or outside of an area where the LADN is available; and iii) if the UE is in a MICO mode, the AMF device notifies the SMF device of the UE being unreachable and the SMF device does not need to send DL data notifications to the AMF device, the AMF device may inform the SMF device that the UE is reachable; and iv) if the SMF device subscribes for a UE reachability status, the AMF device may notify the UE reachability.

According to an example embodiment, if the UE in an IDLE state moves to a new registration area, the UE may connect to a network temporarily for registration to a new network in response to a change in a registration area. Here, active traffic may be absent. During registration to the new network, the AMF device and the SMF device may manage a location of the UE and the SMF device may determine control of a UPF device, such as I-UPF insertion, removal, and relocation. Based on the determination, an operation, such as I-UPF insertion, removal, and relocation may be performed in a session idle state. That is, during registration to the new network in the session idle state, the UPF device may be controlled and thus, potential interruption may be reduced when providing an actual service.

According to an example embodiment, in the case of performing I-UPF control, such as I-UPF insertion, removal, and relocation, in a session idle state, control of the UPF device may be performed and interface between a base station and the UPF device may not be updated. Accordingly, signaling load between a RAN and a core network may be reduced by not updating in the session idle state.

According to an example embodiment, relocation of a PDU session anchor (PSA) that is a UPF device serving as an anchor gateway of a corresponding PDU session based on a session may be performed to not fix a 5G network and manage a flexible data path. Also, to support a network in which the base station and the PSA are not directly connected, at least one intermediate UPF device may be inserted between the base station and the PSA.

<UE Triggered Service Request in CM-CONNECTED State>

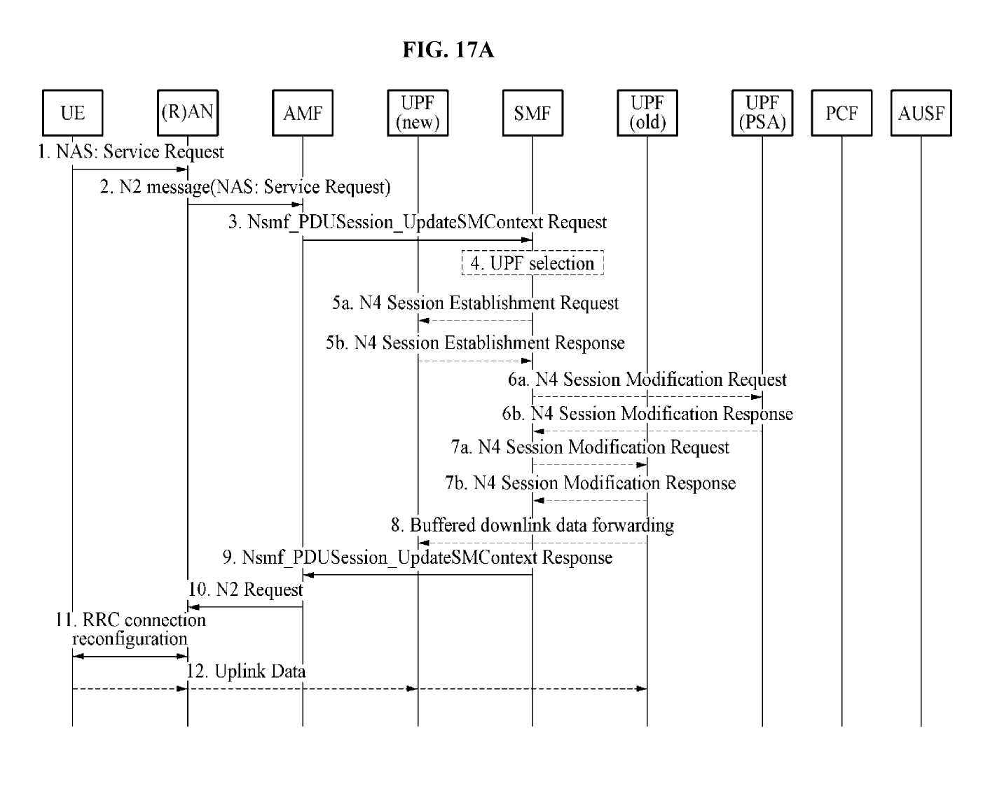

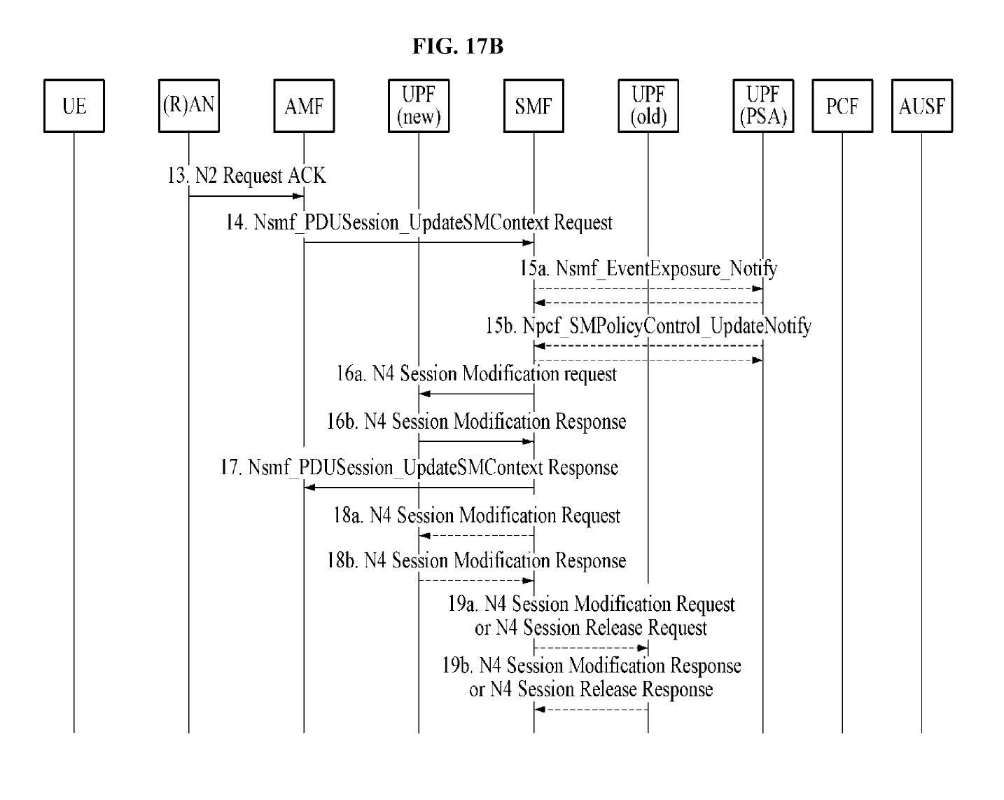

FIGS. 17A and 17B illustrate an example of a UE triggered service request procedure in a CM-CONNECTED state according to an example embodiment.

The service request procedure is used by the UE in the CM-CONNECTED state to request activation of a user plane connection for PDU sessions and to respond to a NAS notification message from the AMF device.

For the UE triggered service request procedure in the CM-CONNECTED state, the impacted SMF device and UPF device may be all under control of a PLMN serving the UE. For example, in a home routed roaming case, the SMF device and the UPF device in an HPLMN may not be involved.

The network may take further actions if user plane connection activation is not successful.

The UE triggered service request procedure may be applied to scenarios with or without the intermediate UPF device, and with or without reselecting the intermediate UPF device.

Referring to FIG. 17A, in operation 1, the UE may send, to the (R)AN, an MM NAS service request (list Of PDU sessions) to be activated, list of allowed PDU sessions).

The UE may send a NAS message service request towards the AMF encapsulated in an RRC message to the RAN. The MM NAS service request message needs to be integrity protected. If the service request is triggered for user data, the UE may identify PDU session(s) of which UP connection is to be activated by including the list of PDU sessions to be activated in the NAS service request message. The UE may not trigger a service request procedure for a PDU session corresponding to a LADN when the UE is outside a service area of the LADN. If the service request over a 3GPP access is triggered in response to a NAS notification message indicating a PDU session associated with the non-3GPP access from the AMF device, the NAS service request message may identify, in the list of allowed PDU sessions, the list of PDU sessions associated with the non-3GPP access that may be re-activated over the 3GPP access.

In operation 2, the (R)AN may send an N2 message (MM NAS service request) to the AMF device.

The (R)AN may forward the MM NAS service request message to the AMF device based on an existing N2 connection. If the service request may not be handled by the AMF device, the AMF device may reject the service request.

In operation 3, the AMF device may send an Nsmf_PDUSession_UpdateSMContext request (PDU session ID(s), cause, UE location information) to the SMF device.

The AMF device may determine the PDU session(s) to be re-activated and send the Nsmf_PDUSession_UpdateSMContext request to SMF(s) associated with the PDU session ID(s), including a current UE location. The cause indicates “establishment of user plane resources.”

Operation 3 may not be performed for PDU session(s) not indicated in the service request. Also, the following operations 4 to 7 and operations 12 to 16 may be omitted for those PDU session(s).

Operations 4 to 9 may be the same as operations 5 to 11 of <UE triggered service request in CM-IDLE state). Here, operation 8 may include operations 9 and 10 of <UE triggered service request in CM-IDLE state>.

In operation 10, the AMF device may send an N2 request (N2 SM information (QoS profile, CN N3 Tunnel Info) received from SMF, MM NAS service accept) to the (R)AN.

If a plurality of PDU Sessions involve a plurality of SMF devices, the AMF device may not need to wait for responses from all the SMF devices in operation 3 before sending N2 SM information to the UE. However, the AMF device may wait for all responses from the SMF devices before sending an MM NAS service accept message to the UE. In the case of the network triggered service request procedure, the AMF device may not send the MM NAS service accept message to the UE.

If activation of UP of the PDU session is rejected by the SMF device, the MM NAS service accept may include an indication of the PDU session ID and a reason why the user plane resources are not activated (e.g., LADN not available).

In operation 11, the (R)AN may perform the following with respect to the UE. The RAN may perform an RRC connection reconfiguration with the UE depending on QoS information for all the QoS flows of the PDU sessions and data radio bearers activated.

If the N2 request includes the MM NAS service accept message, the RAN may forward the MM NAS service accept to the UE.

Here, receiving of the service accept message may not indicate successful activation of user plane radio resources. If not all the requested user plane radio resources are successfully activated, a method of handling this may be defined in operation 3.

In operation 12, once the user plane radio resources for the selected PDU session are set up, uplink data from the UE may be forwarded to the RAN. The NG-RAN may send the uplink data to the UPF address and the tunnel ID provided in operation 10.

In operation 13, the (R)AN may send, to the AMF device, an N2 request ACK (N2 SM information (AN tunnel information, list of accepted QoS flows for PDU Sessions of which UP connections are activated, list of rejected QoS flows for PDU sessions of which UP connections are activated)).

The message may include N2 SM information. For example, If the AMF device sends a separate N2 message in operation 10, the RAN may respond the N2 SM information with the separate N2 message.

If a plurality of pieces of N2 SM information are included in the N2 request message in operation 4, the N2 request ACK may include the plurality of pieces of N2 SM information and information to enable the AMF device to associate the responses with a relevant SMF device.

Operations 14 to 19 may be the same as operations 16 to 20 of <UE triggered service request in CM-IDLE state>.

According to an example embodiment, if the UE in an IDLE state moves to a new registration area, the UE may connect to a network temporarily for registration to a new network in response to a change in a registration area. Here, active traffic may be absent. During registration to the new network, the AMF device and the SMF device may manage a location of the UE and the SMF device may determine control of a UPF device, such as I-UPF insertion, removal, and relocation. Based on the determination, an operation, such as I-UPF insertion, removal, and relocation may be performed in a session idle state. That is, during registration to the new network in the session idle state, the UPF device may be controlled and thus, potential interruption may be reduced when providing an actual service.

According to an example embodiment, in the case of performing I-UPF control, such as I-UPF insertion, removal, and relocation, in a session idle state, control of the UPF device may be performed and interface between a base station and the UPF device may not be updated. Accordingly, signaling load between a RAN and a core network may be reduced by not updating in the session idle state.

<General Registration>

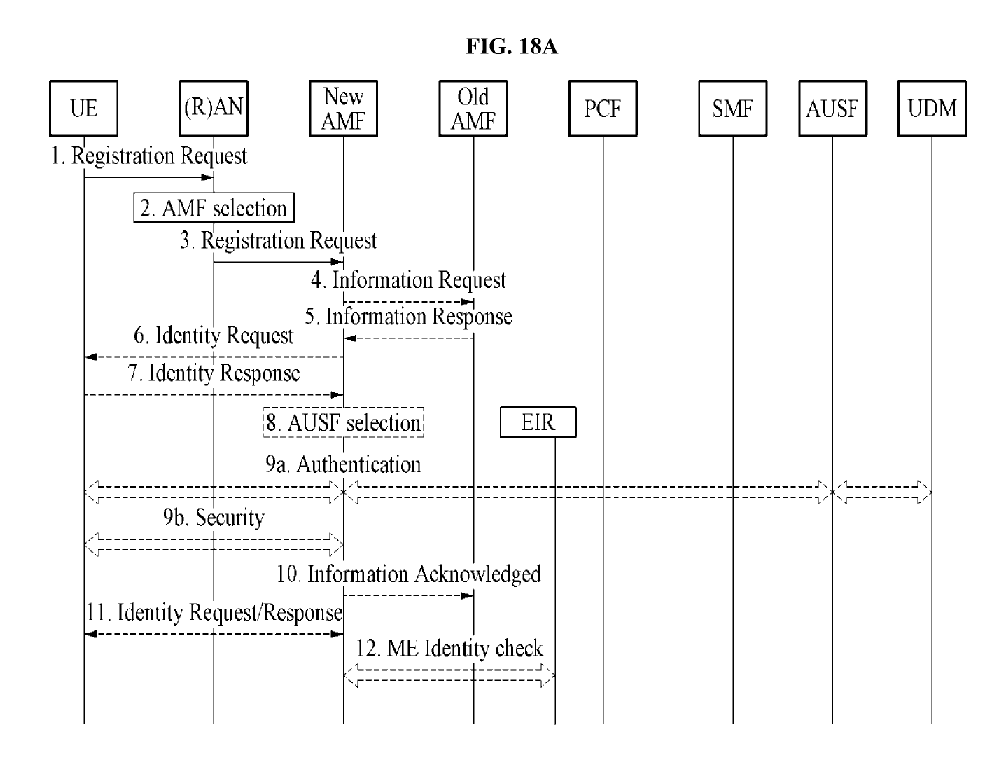

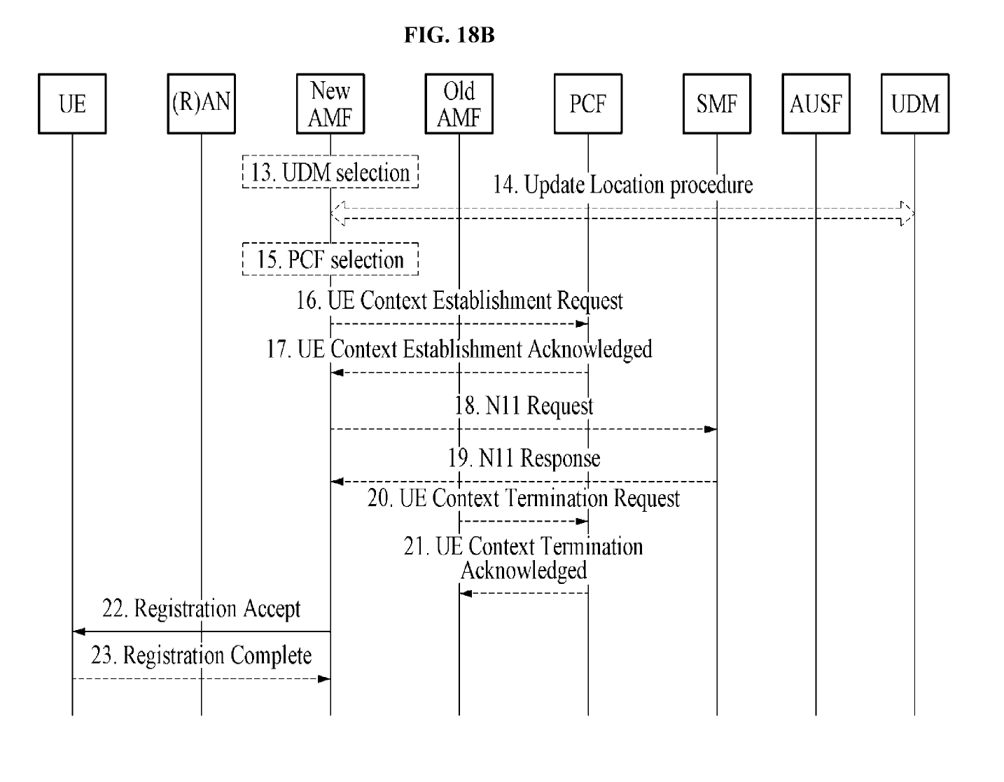

FIGS. 18A and 18B illustrate another example of a UE registration procedure in a communication system according to an example embodiment.

Referring to FIG. 18A, in operation 1, the UE may send, to the (R)AN, an AN message (AN parameters, registration request (registration type, SUPI or 5G-GUTI, security parameters, NSSAI, UE 5GC capability, PDU session status, PDU session(s) to be re-activated, and MICO mode preference)).

In case of the 5NG-RAN, the AN parameters may include the SUPI or the 5G-GUTI, the selected network, and NSSAI.

The registration type may indicate whether the UE desires to perform an “initial registration” (i.e., the UE is in an RM-DEREGISTERED state), a “mobility registration update” (i.e., the UE is in an RM-REGISTERED state and initiates a registration procedure due to mobility), a “periodic registration update” (i.e., the UE is in the RM-REGISTERED state and initiates a registration procedure due to expiry of a periodic registration update timer). If the UE performs the initial registration (i.e., the UE is in the RM-DEREGISTERED state) to a PLMN for which the UE does not have the 5G-GUTI, the UE may include its SUPI in the registration attempt. In other cases, the 5G-GUTI may be included and may indicate a last serving AMF device. If the UE is registered over the non-3GPP access in a PLMN different from the new PLMN (i.e., not the registered PLMN or an equivalent PLMN of the registered PLMN) of the 3GPP access, the UE may not provide, over the 3GPP access, the 5G-GUTI allocated by the AMF device during the registration procedure over the non-3GPP access. Also, if the UE is already registered over the 3GPP access in the PLMN (i.e., the registered PLMN), different from the new PLMN (i.e., not the registered PLMN or an equivalent PLMN of the registered PLMN) of the non-3GPP access, the UE may not provide, over the non-3GPP access, the 5G-GUTI allocated by the AMF device during the registration procedure over the 3GPP access. The UE may provide a usage setting of the UE based on its configuration.

The security parameters are used for authentication and integrity protection. The NSSAI represents network slice selection assistance information. The PDU session status indicates the previously established PDU sessions in the UE. The PDU session(s) to be re-activated may be included to indicate the PDU session(s) for which the UE intends to activate UP connections.

In operation 2, the following may be performed. If the SUPI is included or the 5G-GUTI does not indicate a valid AMF device, the (R)AN may select an AMF device based on the (R)AT and the requested NSSAI. If the (R)AN is incapable of selecting an appropriate AMF device, the (R)AN may perform AMF device selection by forwarding the registration request to an AMF device that is configured in the (R)AN.

In operation 3, the (R)AN may send, to a new AMF device, an N2 message (N2 parameters, registration request (registration type, subscriber permanent Identifier or 5G-GUTI, security parameters, NSSAI and MICO mode preference)). When the 5G-RAN is used, the N2 parameters may include location information, a cell identity and a RAT type related to a cell in which the UE is camping. If the registration type indicated by the UE is periodic registration update, the following operations 4 to 17 may be omitted.

In operation 4 that is conditionally performed, the new AMF device may send an information request (complete registration request) to an old AMF device.

If the 5G-GUTI of the UE is included in the registration request and the serving AMF device is changed since last registration, the new AMF device may send the information request to the old AMF, including the complete registration request IE to request the SUPI and MM context of the UE.

In operation 5 that is conditionally performed, the old AMF device may send an information response (SUPI, MM context, SMF information) to the new AMF device.

The old AMF device may respond with the information response to the new AMF device including the SUPI and the MM context of the UE. If the old AMF device holds information about active PDU sessions, the old AMF device may include SMF information including SMF identities and PDU session identities.

In operation 6 that is conditionally performed, the new AMF device may send an identity request to the UE. If the SUPI is not provided from the UE or not retrieved from the old AMF device, the identity request procedure may be initiated by the AMF device sending an identity request message to the UE.

In operation 7 that is conditionally performed, the UE may send an identity response to the new AMF device. The UE may respond with an identity response message including the SUPI.

In operation 8, the AMF device may determine to invoke an AUSF. In this case, the AMF device may select the AUSF based on the SUPI.

In operation 9a, the AUSF may initiate authentication of the UE. If network slicing is used, the AMF device may determine if the registration request needs to be rerouted. In operation 9b, the AMF device may initiate NAS security functions.

In operation 10 that is conditionally performed, the new AMF device may send information acknowledged to the old AMF device. Here, if the AMF device is changed, the new AMF device may acknowledge the transfer of the UE MM context.

If the authentication/security procedure fails, the registration may be rejected and the new AMF device may send a reject indication to the old AMF device. The old AMF device may continue as if the information request is not received.

In operation 11 that is conditionally performed, the new AMF may send the identity request to the UE. If a PEI is not provided from the UE or not retrieved from the old AMF device, the identity request procedure may be initiated by the AMF device sending an identity request message to the UE to retrieve the PEI.

In operation 12, the new AMF device may optionally initiate a ME identity check.

If operation 14 is to be performed, the new AMF device may select a UDM device based on the SUPT in operation 13.

In operation 14, the following may be performed. If the AMF device is changed since the last registration, if a valid subscription context for the UE is absent in the AMF device, if the UE provides a SUPI that does not refer to a valid context in the AMF device, or if the UE registers to the same AMF device that is already registered to the non-3GPP access (i.e., the UE is registered over the non-3GPP access and initiates this registration procedure to add the 3GPP access), the new AMF device may initiate the update location procedure. The new AMF device may provide the access type the new AFF device serves for the UE to the UDM device and the access type may be set to “3GPP access.” The UDM device may store an associated access type together with the serving AMF device. This will cause the UDM device to initiate a cancel location to the old AMF device corresponding to the 3GPP access, if one exists. The old AMF device may remove the MM context and may notify all possibly associated SMF device(s), and the new AMF device may create an MM context for the UE after obtaining AMF related subscription data from the UDM device.

In operation 15, the new AMF device may conditionally select a PCF device based on the SUPI.

In operation 16, the new AMF device may optionally send a UE context establishment request (SUPI) to the PCF device. If the AMF device does not obtain an access and mobility policy for the UE or if the access and mobility policy in the AMF device is no longer valid, the AMF device may request the PCF device to apply operator policies for the UE.

In operation 17, the PCF device may send a UE context establishment acknowledged message (access and mobility policy data) to the new AMF device. The PCF device may acknowledge the UE context establishment request message and may provide the access and mobility policy data for the UE to the AMF device.

In operation 18, the new AMF device may send an N11 request to the SMF device.

The N11 request may be sent in one or both of the following scenarios:

i) If the AMF device is changed, the new AMF device may notify each SMF device of the new AMF device serving the UE. The AMF may verify a PDU session status from the UE with available SMF information. If the AMF device is changed, it is assumed that the old AMF device may provide the available SMF information. The new AMF device may request the SMF device to release any network resources related to PDU sessions that the UE indicates as not established. ii) If the UE is in a MICO mode and the AMF device notifies the SMF device of the UE being unreachable and that the SMF device does not need to send DL data notifications to the AMF device, the AMF device may inform the SMF device that the UE is reachable.

The AMF device may notify other NFs that subscribe to UE reachability that the UE is reachable. If the AFM device detects that the UE is outside an area of interest subscribed by the SMF device serving the UE, the AMF device may inform the SMF device of new location information of the UE.

In operation 19, the SMF device may send an N11 response to the new AMF device. The SMF device may determine to trigger, for example, a new intermediate UPF insertion or UPF relocation. If the registration type indicated by the UE is periodic registration update, the following operations 20 and 21 may be omitted.

In operation 20 that is conditionally performed, the old AMF device may send a UE context termination request to the PCF device. If the old AMF device previously requests UE context to be established in the PCF device, the old AMF device may terminate the UE context in the PCF device.

In operation 21, the PCF may send a UE context termination acknowledged message to the old AMF device.

In operation 22, the new AMF device may send, to the UE, a registration accept (5G-GUTI, registration area. Mobility restrictions, a PDU session status, NSSAI, periodic registration update timer, LADN information, and accepted MICO mode).

The AMF device may send a registration accept message to the UE indicating that the registration is accepted. if the AMF device allocates a new 5G-GUTI, the 5G-GUTI may be included. Mobility restrictions may be included if mobility restrictions apply to the UE. The AMF device may indicate the established PDU sessions to the UE in the PDU session status. The UE may remove locally any internal resources related to PDU sessions that are not marked as established in the received PDU session status and for which the UE requests a PDU session establishment and does not receive the SMF response. If the PDU session status information is in the registration request, the AMF device may indicate the PDU session status to the UE. The NSSAI may include the allowed S-NSSAI. If the UE subscription data includes subscribed LADN identification information, the AMF device may include, in the registration accept message, LADN information about LADNs that are available within the registration area determined by the AMF device for the UE. If the UE includes the MICO mode in the request, the AMF device may respond regarding whether the MICO mode needs to be used.

If the “PDU session(s) to be re-activated” is included in the registration request, the AMF device may send an N11 message to the SMF device(s) associated with the PDU session ID(s) to establish the user plane(s) for the PDU session(s) in conjunction with the registration accept message.

In operation 23 that is conditionally performed, the UE may send a registration complete to the new AMF device. The UE may send a registration complete message to the AMF device if the new 5G-GUTI is assigned. When the “PDU session(s) to be re-activated” is not included in the registration request, the AMF device may release the signaling connection with the UE.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include a plurality of processing elements and a plurality of types of processing elements. For example, a processing device may include a plurality of processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of relocating a session and service continuity (SSC) mode 2 protocol data unit (PDU) session anchor by a session management function (SMF) device, the method comprising:
determining a relocation of a PDU session anchor;
releasing a PDU session associated with an old PDU session anchor by sending, to a user equipment (UE), N1 SM information that includes a PDU session release command message through an access and mobility management function (AMF) device; and
selecting a new PDU session anchor to establish a PDU session associated with the new PDU session.

2. The method of claim 1, wherein the PDU session release command message includes a PDU session ID that needs to be relocated.

3. A method of relocating a session and service continuity (SSC) mode 3 protocol data unit (PDU) session anchor by a session management function (SMF) device, the method comprising:
determining a relocation of a PDU session anchor;
sending, to an access and mobility management function (AMF) device, Namf_Communication_N1N2MessageTransfer that includes a PDU session ID indicating a PDU session to be relocated; and
releasing a PDU session associated with an old PDU session anchor after establishment of a PDU session between a user equipment (UE) and a new PDU session anchor.

4. The method of claim 3, wherein the Namf_Communication_N1N2MessageTransfer includes a cause indicating that a PDU session re-establishment in the same data network is required and information regarding whether the SMF device needs to be reallocated.

5. The method of claim 3, wherein the old PDU session anchor releases an old PDU session using the UE before expiry of a timer indicating a time in which the old PDU session is maintained or releases the old PDU session using the SMF device until the timer expires.

6. A method of relocating a session and service continuity (SSC) mode 3 protocol data unit (PDU) session anchor by an access and mobility management function (AMF) device, the method comprising:
receiving Namf_Communication_N1N2MessageTransfer that includes a PDU session ID indicating a PDU that needs to be relocated in response to a session management function (SMF) device determining a relocation of a PDU session anchor from an old PUD session anchor to a new PDU session anchor; and
sending, to a user equipment (UE), a PDU session modification command message that includes a cause indicating that a PDU session re-establishment in the same data network is required and a time in which a PDU session is maintained.

7. The method of claim 6, wherein the Namf_Communication_N1N2MessageTransfer includes information regarding whether the SMF device needs to be reallocated.

8. The method of claim 6, wherein the old PDU session anchor releases an old PDU session using the UE before expiry of a timer indicating a time in which the old PDU session is maintained or releases the old PDU session using the SMF device until the timer expires.
